(19) United States
(12) Patent Application Publication
(10) Pub. No.: US 2003/0018481 A1
(43) Pub. Date: Jan. 23, 2003

(54) Method and apparatus for generating configurable documents

(76) Inventors: Cheng Zhou, Austin, TX (US); Charles Erickson, Cedar Park, TX (US)

Correspondence Address: THE HECKER LAW GROUP, 1925 CENTURY PARK EAST, SUITE 2300, LOS ANGELES, CA, 90067, US

(21) Appl. No.: 09/810,515

(22) Filed: Mar. 15, 2001

(51) Int. Cl. G06F 17/60

(52) U.S. Cl. 705/1

(57) ABSTRACT

In an embodiment of the invention the documents discussed herein are representative of a document or set of documents that are customized to fit a particular situation. Thus, the invention enables users to generate a document that represents a specific arrangement between parties. For instance embodiments of the invention may be utilized to generate contracts relating to the sale or distribution of a certain product. Each document that is generated by the system is comprised of a set of interrelated components. Each of the components is assembled into a document template that when processed by a configuration engine forms a configured document. Each document template may comprise one or more textual components and/or compensation components. [The textual components comprise subject specific text that can be integrated into the document during the assembly processes. Compensation components comprise information relating to a schema for paying individual commissions. Each compensation component may draw from a commission model and utilize the bonus and quota components thereof.] During processing of the document template, the configuration engine may use a set of rules as input. These rules define the interrelationship between the various components of the document.

### FIELD OF THE INVENTION

This invention relates to the field of computer software. More specifically, the invention relates to a method and apparatus for generating configurable documents.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyrights whatsoever.

### BACKGROUND

Contracts and many other types of agreements or documents are tightly integrated into many aspects of modem business. Companies often utilize such agreements to formalize the terms of a business relationship. For example, if a company is asked to perform a particular service for another company, a contract that specifies what types of services are to be performed, when those services are to be completed, and what the terms of payment are may be signed by both parties involved in the transaction. Creating the documents that relates to such business relationships is a complex process that often requires the involvement of attorneys or businessmen who are familiar with the details associated with the type of transaction or relationship being established. The involvement of such people usually requires a significant time investment from the people responsible for producing such a document. This can be prohibitively expensive in terms of the time or costs associated with involving the people having the appropriate expertise. However, the quality and value of the document that is ultimately generated largely depends upon the expertise of the documents drafter. A problem that exists during the conclusion of many different business deals is that the document drafter having the most expertise the transaction to be concluded may not be available at the time the transaction is to be culminated. The problem increases if the document to be drafted carries any legal weight.

Existing systems provide a mechanism for generating contracts. For example, ContractMaker™, a product created by Digital Contracts, Inc. provides users with a way to generate contracts. The software contains a collection of numerous possible documents which subscribers can assemble interactively online. If the user has a valid subscription, the user is presented an interface for assembling the various part of the contract (e.g., steps 100 and 102). The interface enables the subscribing user to obtain access to a library of contract documents. Users may subscribe to different libraries in order to obtain contract documents covering different subject matter. The user may select from a variety of different contract types (e.g., step 104) and the system will then begin prompting the user for information to be filled into the contract. For example, current versions of the system may prompt the user for information about the parties to the contact (e.g., step 106). Once the parties are identified, the system presents a questionnaire to the user (e.g., step 108). The questionnaire embodies a logic tree which determines the questions, and their order and sequence. Questions are presented one-at-a-time as determined by the users answers to prior questions. Once the user completes all the questions in the logic tree (e.g., step 110) the system assembles the contract (e.g., step 112) and presents the drafted contract to the user. The user may edit the contact via a word processor and may change the assumptions or answers to questions by back-tacking through the logic tree (e.g., via a wizard interface).

Although the ContractMaker™ is a good tool for creating contracts, it does not provided users with a flexible way to build a framework for generating various types of documents. Moreover, the system requires that the user build the document in sequence by traversing the logic tree associated with a particular contract document. Because of these and other limitations there is a need for a system that provides users with a more flexible way to generate documents.

In the foregoing discussion about current systems, the problems and limitations set forth as existent in the prior art are provided for exemplarily purposes. It should be clear to one of ordinary skill in the art that these problems also exist in other contexts or professions and that the invention may apply to situations other than the ones described herein.

### SUMMARY OF THE INVENTION

An embodiment of the invention provides users with a flexible tool for defining and subsequently generating different types of documents. For instance embodiments of the invention may be utilized to generate contracts relating to the sale or distribution of a certain product or set of products. The contracts that are ultimately generated can be customized to fit the situation for which the contract is intended. For example, the invention may provide sales representatives with a tool for generating contracts that relate to the product the representative is selling.

Each document the system generates is created in accordance with a set of rules that define the content that may be inserted into the document. These rules may be defined by anyone having detailed knowledge of the business processes involved in the transaction at issue (e.g., sales transactions). However, once the rules are identified users of some embodiments of the invention are not required to have such knowledge. Thus, a manager could define the rules and a sales representative that does not have knowledge of the business information needed to determine the rules may utilize embodiments of the invention to generate documents.

When any user (e.g., a manger or sales representative) issues a command to generate a document, the document is automatically assembled from a set of interrelated components. Each of the components is stored in a document template that represents a series of related or unrelated components. However, in one embodiment of the invention the components that make up a document template all belong to a certain classification. For example, a document template may contain a set of components that represent the various provisions associated with a contract to sell different types of insurance. A first component may identify the commission amounts to be distributed to representatives who sell an associated insurance policy and a second component may contain text in support of the various contract provisions used when that type of insurance policy is sold. In one embodiment of the invention, the components that identify commission amounts are referred to as compensation components and the components that contain text are referred to as textual components.

Each document template may comprise one or more textual components and/or compensation components that are related to one another in some context (e.g., associated with the same product). The textual components may comprise specific text that can be integrated into the document during the assembly processes. Compensation components comprise information relating to a schema for paying out individual commissions. Each compensation component may draw from a commission model and utilize the bonus and quota components thereof. During processing of the document template, the configuration engine may use a set of rules as input. These rules define the interrelationship between the various components in the document template.

Component-to-component relationships (also referred to as rules) can be created between components within a document template. These relationship definitions identify how each of the components may contribute value to a generated document. In accordance with one embodiment of the invention a relationship is established for one or more of the components that make up the document template. These relationships are therefore defined and later applied to groups of components contained in the document template. The rule sets for each group may be customized to reflect the underlying business logic associated with the document to be generated and multiple document templates can be created.

Once the interrelationships between each of the components comprising a document template are defined, those relationships are stored as rule sets to be processed by a configuration engine. If the user requests a document, a document template is obtained from memory and utilized by the configuration engine to generate the requested document. The configuration engine therefore creates a document with the appropriate components by utilizing the relationships defined in each document template to determine which components can be appropriately placed in the document.

### DESCRIPTION OF THE DRAWINGS

FIG. 1 illustrates a prior art technique for generating contract documents.

FIG. 2 comprises a flow diagram for generating a configurable document in accordance with one embodiment of the invention.

FIG. 3 comprises a block diagram illustrating the elements of an example document template in accordance with one embodiment of the invention.

FIG. 4 comprises a block diagram illustrating the association between compensation components and a commission engine in accordance with one embodiment of the invention.

FIG. 5 illustrates how an embodiment of the invention provides a document template to the configuration engine to apply a rules set and thereby generate a configured document.

FIG. 6 illustrates a commission model in accordance with one embodiment of the invention.

FIG. 7 illustrates the components of a template maintenance system according to an embodiment of the invention.

FIG. 8 comprises an illustration of the contents of a component repository according to an embodiment of the invention.

FIG. 9 illustrates relationships between components according to an embodiment of the invention.

FIG. 10 provides an example of classification performed by the configuration engine according to an embodiment of the invention.

FIG. 11 shows a general-purpose hardware environment utilized to implement one or more embodiments of the invention.

FIG. 12a comprises an example selling agreement in accordance with one embodiment of the invention.

FIG. 12b comprises an example of a broker/dealer selling agreement in accordance with one embodiment of the invention.

FIG. 13a comprises an example of an administrative services selling agreement in accordance with one embodiment of the invention.

FIG. 13a comprises an example of a selling agreement in accordance with one embodiment of the invention.

FIG. 14a comprises an example of a selling agreement in accordance with one embodiment of the invention.

FIG. 14b comprises an example of a selling agreement in accordance with one embodiment of the invention.

FIG. 15 comprises an object instance diagram in accordance with an example embodiment of the invention.

FIG. 16 comprises transactions executed in accordance with an example embodiment of the invention.

FIG. 17 comprises additional transactions executed in accordance with an example embodiment of the invention.

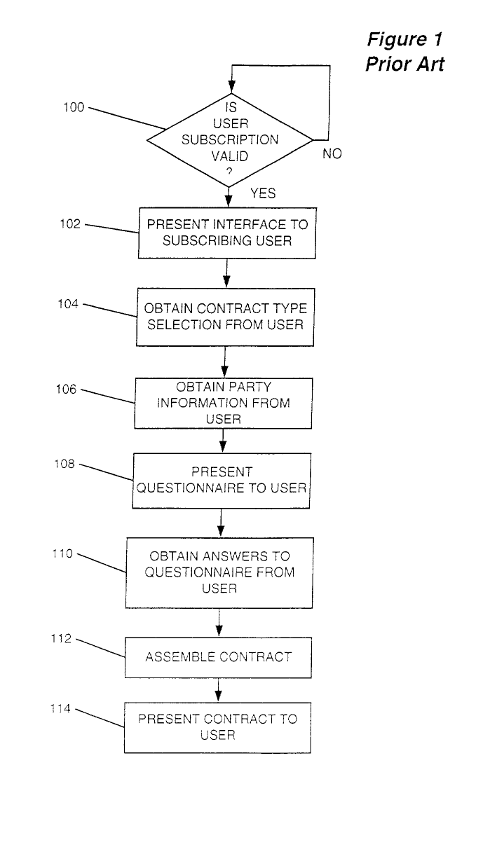

### DETAILED DESCRIPTION

A method and apparatus for generating configurable documents is described. In the following description numerous specific details are set forth in order to provide a more thorough understanding of the present invention. It will be apparent, however, to one skilled in the art, that the present invention may be practiced without these specific details. In other instances, well-known features have not been described in detail so as not to obscure the invention. The term system as utilized throughout this document comprises computer software, hardware, and the methods and processes executing therein.

System Overview

An embodiment of the invention provides users with a flexible tool for defining and subsequently generating different types of documents. For instance embodiments of the invention may be utilized to generate contracts relating to the sale or distribution of a certain product or set of products. The contracts that are ultimately generated can be customized to fit the situation for which the contract is intended. For instance, if a supplier and a distributor meet to negotiate a deal, and both parties come to an agreement that provides for compensation to the distributor's sales team (or to the distributor itself) according to a certain compensation plan, a document that represents the terms of that agreement can be instantaneously generated using embodiments of the invention. Thus, the supplier (e.g., a manufacturer, producer, supply house, or financial institution) may present the distributor or it's representatives with a document that details the negotiated agreement prior to the end of the meeting.

When any user (e.g., a distributor, manger or sales representative) issues a command to generate a document, the document is automatically assembled from a set of interrelated components. Each of the components may be stored in a document template that represents a series of related or unrelated components. However, in one embodiment of the invention the components that make up a document template all belong to a certain classification. For example, a document template may contain a set of components that represent the various provisions associated with a contract to sell different types of products (e.g., insurance). A first component may identify the commission amounts to be distributed to representatives who sell an associated insurance policy and a second component may contain text in support of the various contract provisions used when that type of insurance policy is sold. In one embodiment of the invention, the components that identify commission amounts are referred to as compensation components and the components that contain text are referred to as textual components.

Each document template may comprise one or more textual components and/or compensation components that are related to one another in some context (e.g., associated with the same product). The textual components may comprise specific text that can be integrated into the document during the assembly processes. Compensation components comprise information relating to a schema for paying out individual commissions. Each compensation component may draw from a commission model and utilize the bonus and quota components thereof. During processing of the document template, the configuration engine may use a set of rules as input. These rules define the interrelationship between the various components in the document template.

Using the document generating system described herein a user can interactively select and configure a document among a set of related documents based on availability and compatibility of various components. The system does not impose an order in the selection of documents or components, but allows the user to only make valid component selections. However, such selections can be made in any order.

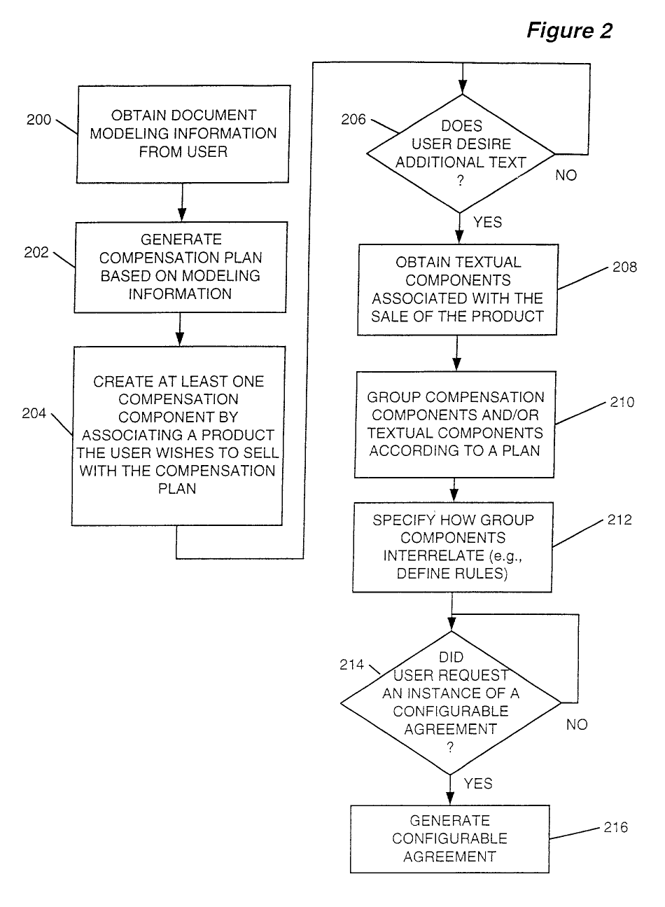

FIG. 2 comprises a flow diagram illustrating the process of generating a document in accordance with one embodiment of the invention. To develop the components that may comprise a document, a document designer instantiates a document modeling interface. The document-modeling interface provides multiple mechanisms for collecting information from the document designer that is utilized to specify the contents and interrelationship between components. In one embodiment of the invention, the document-modeling interface is utilized to obtain modeling information from a user such as the document designer (e.g., step 200). The document designer may be any user with knowledge of the business processes involved in the transaction or set of transactions at issue (e.g., sales transactions). However, once the document designer defines the document, other users may utilize the system to generate documents. In one embodiment of the invention, the modeling information entered into the system by the document designer comprises data that may be utilized to generate a compensation plan. For instance, if the user is designing a document that is intended to define the terms of an arrangement between two companies, the modeling information comprises various aspects of the arrangement. For example, assume that financial services company X wants to create an agreement with distributor Z wherein the distributor (or representatives associated with the distributor) will sell a given product. The modeling information that would be something split into a couple of categories.

a) The quota levels, i.e. 50 units, 80 units, 150 units these define thresholds where the distributor gets paid a higher percentage due to higher sales.

b) Bonus levels, such as 5%, 7%, 15%. These levels correspond to the quota levels and define the rate to pay for reaching those quota levels.

Once enough modeling information is collected to formulate a definitive compensation plan, the system embodying the invention may utilize the modeling information to generate the compensation plan (e.g., step 202).

Compensation Components

The user may generate one or more compensation plans and such plans may each comprise one or more compensation alternatives. In one embodiment of the invention, the compensation plans provide the basis for creating one or more compensation components (e.g., step 204). Each compensation component is associated with one or more products the user wishes to promote via the compensation plan.

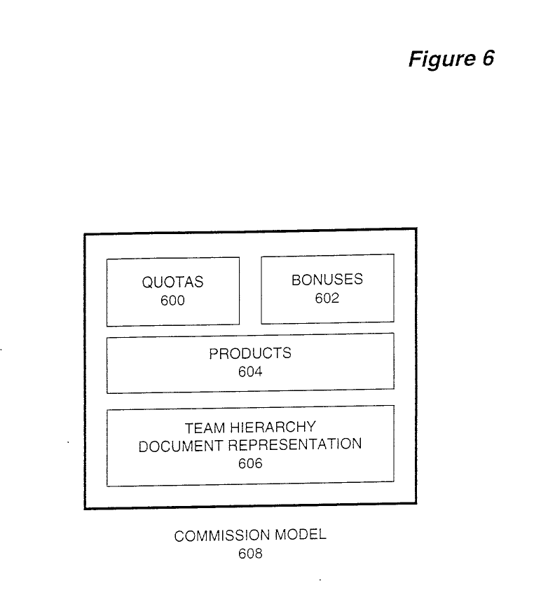

Each compensation component may be generating using a commission model adapted to interface with the document generating system. In accordance with one embodiment of the invention, each commission model comprises a collection of rule sets. These rules sets allow the business user to define any number of arbitrary properties (also referred to as hierarchies) that model the structures associated with a business, such as a business' customers, products, and sales teams (in addition to a default model that specifies a set of hierarchies). A different rule set may be stored for each sales team or sales representative responsible for selling products or services of the business. FIG. 6 illustrates the components of a commission model in accordance with an embodiment of the invention. In this instance, each sales team represents a hierarchy. Individuals in the hierarchy are abstracted out and what is stored comprises a document or agreement relationship 606. The commission model may also comprise information about products 604 that a sales team or sales representative may sell and/or information identifying quotas 600 or bonuses 602 associated with those products.

The commission model is described in further detail in pending patent application Ser. No. 09/081857, entitled “Method and Apparatus For Determining Commission”, which in incorporated herein by reference. Each compensation component may comprise some or all of the output generated by a commission engine or utilizing the commission model. The reader should note that in some instances the commission model generated by the commission engine is migrated into the system for generating configurable documents using database migration techniques well know to those of ordinary skill in the art. In other instances, the commission model is seamlessly integrated with the document generating system described herein.

The system may generate one or more compensation components from the compensation plan information defined by the user. For instance, individual products may each have separate compensation components. Suites or groups of products may also share the same compensation component.

Textual Components

Once the system generates one or more compensation components, the user is prompted to indicate whether any additional text is required (e.g., step 206). The invention contemplates the integration of many different types of text. Each set of text pertains to an identifiable subject and is stored in a form called a textual component. Each textual component comprises a set of words representative of a definable concept. Textual components are extensible such that each component may be configured to encompass text data supportive of any portion of the document that is to be generated.

Embodiments of the invention contemplate the use of textual components that, for example, contain contractual language. Thus, each textual component may represent different provisions of a contact. One textual component may, for instance, be representative of a duties & obligation provision, another textual component may be representative of a warranties and indemnities provision or a termination clause. Textual components may also include remedy provisions arbitration provisions, merger provisions, or other contractual or non-contractual language. Moreover, each textual component may be customized so that it relates to the purpose of the document. For instance, if additional contract language is required when certain types of products are sold, a textual component that comprises such language may be written and incorporated into the system. Thus, textual components provide an extensible mechanism for integrating relevant language into the document template which is in turn utilized to generate a document such as a contract.

The reader should note that the invention also contemplates the use of textual components that relate to various other aspects of a document. The invention is not limited solely to the creation of contracts, but may also be utilized to generate any other sort of document related to a business transaction. Documents such as letters of intent, Request For Proposals (RFPs), bids, memos, letters, etc . . . may generated via embodiments of the invention. Textual components are typically predefined by a system designer, but may also be created or modified by other users. When the user desires customized text (e.g., at step 206), the system is configured to obtain textual components relating to the situation for which the document is intended. For example, if the user is generating a document that comprises an agreement to sell or distribute a certain product (e.g., life insurance), the textual component that is obtained will relate to the product to which the transaction pertains. In one embodiment of the invention this occurs at step 208 where the system obtains one or more textual components associated with a particular product.

Document Templates

Once the compensation components and textual components are defined or identified, the user may formulate one or more document templates comprised of one or more differing sets of components. Each document template may be representative of a certain set of related products. Thus, document templates may serve as the framework for generating documents relating to a particular product or product line. The designing user may define a product line, by identifying the components that relate to a particular product and incorporating those components into a product line. Document templates may also contain categories of components that relate to concepts other than products.

Each document template provides the basis from which one or more documents are ultimately generated. Each document templates may therefore contain more components than ultimately appear in the final document. A user-interface provides the user with a mechanism for generating document templates using various operations such as drag and drop and item selection.

Each document template may include an identification of the components that comprise the template and the interrelationships between the components. The interrelationships are conceptually easy for the user to understand. The same relationships are used by one embodiment of the invention to define and configure any system. An external representation that includes these relationships allows a user to view and maintain the definition. The external representation provides a graphical way to manipulate components however, the external representation is translated into an internal representation that is designed to decrease processing time and increase response time.

During a document configuration session, the invention is capable of allowing a user to select or unselect components without imposing a flow on the user. There is no order imposed on the user in terms of the sequence in which components are selected for inclusion in the document template. No order is imposed on the user and there is no requirement, for example, that the user remove components of a document template in the order in which they were added. No fixed flow or order is required to edit a given document template. Thus, users are not required to follow a fixed logic tree. For example, it is not necessary to select a required component before choosing an optional component so long as the required component is eventually selected. The invention can identify the components that are still available based on the options that have already been selected. Further, a user can unselect an item (e.g., delete the item from the template) without regard to the order in which it was added to the template.

Each document template serves as the input provided to a configuration engine which utilizes rules to formulate a document in a manner consistent with the rules. A document template may, for instance, contain a collection of compensation component and multiple textual components that relate to a particular product. In one embodiment of the invention each document template comprises a group of compensation components and textual components assembled according to a plan (e.g., step 210).

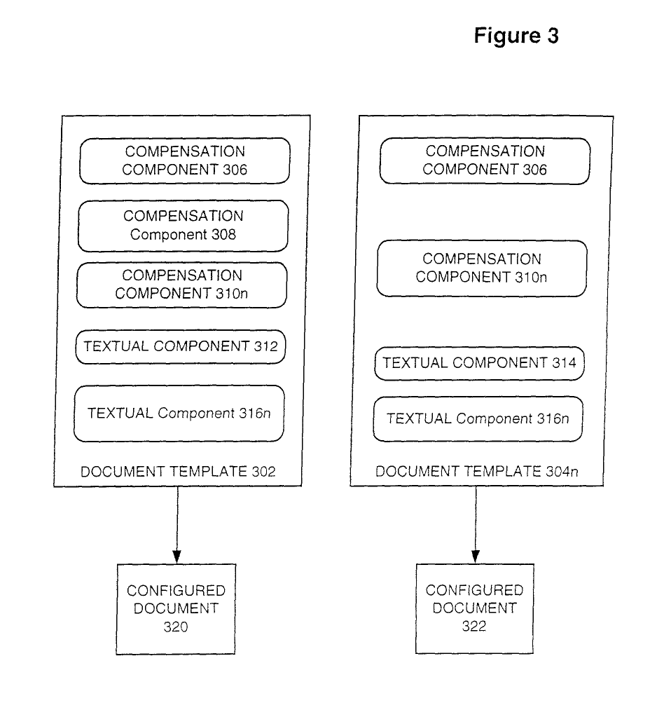

FIG. 3 illustrates the composition of a document template in accordance with one embodiment of the invention. Document template 302 comprises a set of compensation components 306-310n. Compensation component 310n represents the notation that the user may identify any number of compensation components and associate those compensation components with a particular document template. Thus, document template 302 may comprise one or more compensation components that relate to the product or products about which document template 302 pertains. Each document template the user creates may share some or none of the compensation components integrated into other document templates.

In accordance with one embodiment of the invention document template 302 may also comprise textual components 312 and 316n. Textual component 316n is representative of any number of textual components relevant to the subject matter of document template 302. FIG. 3 also includes document template 304n which represents any number of document templates. The components of document template 304n are interchangeable and may be defined by the designer to include components that differ from or share some of the components in document template 340n. In one embodiment of the invention document template 304n comprises compensation components 306 and 310n as well as textual components 314 and 316n. For instance compensation component 306 may represent a commission that will be earned when a sales representative sells a particular product and textual component 314 may represent contractual language about the conditions of the sale. The designer may create any number of document templates. Each template may be utilized to generate an instance of a document. For example, in FIG. 3, document template 302 may be used as the basis for generating document 320. Document 320 may contain some or all of the components associated with document template 302. In one embodiment of the invention, document 320 contains a subset of the components in document template 302. The exact composition of that subset depends upon the relationships established between each of the components. Similarly, document template 304n provides the basis for document 322. Documents 320 and 322 are both illustrative of the output formulated by a configuration engine.

Template Maintenance System

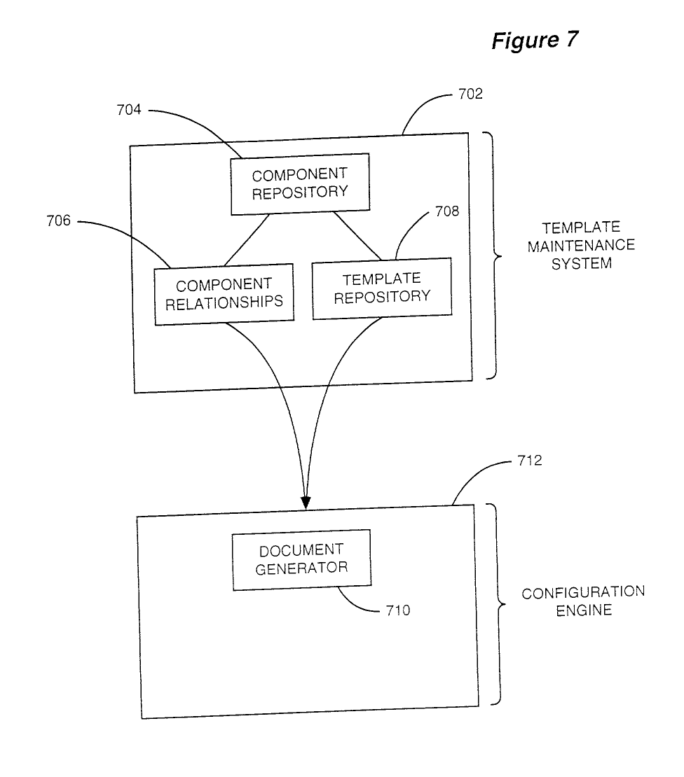

FIG. 7 provides an overview of a template maintenance system according to an embodiment of the invention. The template maintenance system provides a mechanism for creating, maintaining, or modifying the components and relationships that make up each document template. Template maintenance system 702 maintains a components repository 704, component relationships 706 and document template repository 708. Template maintenance system 702 comprises an interface that provides users with ability to add components to components repository 704, specify component relationships 706 and thereby define the contents document template repository 708. Components and component relationship can also be modified using the template maintenance system. The user interface may display a set of hierarchies that provide a conceptually easier way of viewing a component definition. In one embodiment of the invention the system stores a set of hierarchies that represent the relationships defined. The stored hierarchies map the external representation provided by the user to an internal representation. The internal representation may be stored as a document definition and are associated with document templates held in the document repository. The document generator 710 associated with configuration engine 712 may utilizes these internal representations to formulate the finalized document.

Components repository 704 comprises textual and compensation components that are related to a particular product and/or document. Similar components are grouped together to form a component hierarchy that allows for a simplified maintenance of the hierarchy. For example, when a group of components is assigned a behavior, all the members associated with that group inherit that behavior automatically.

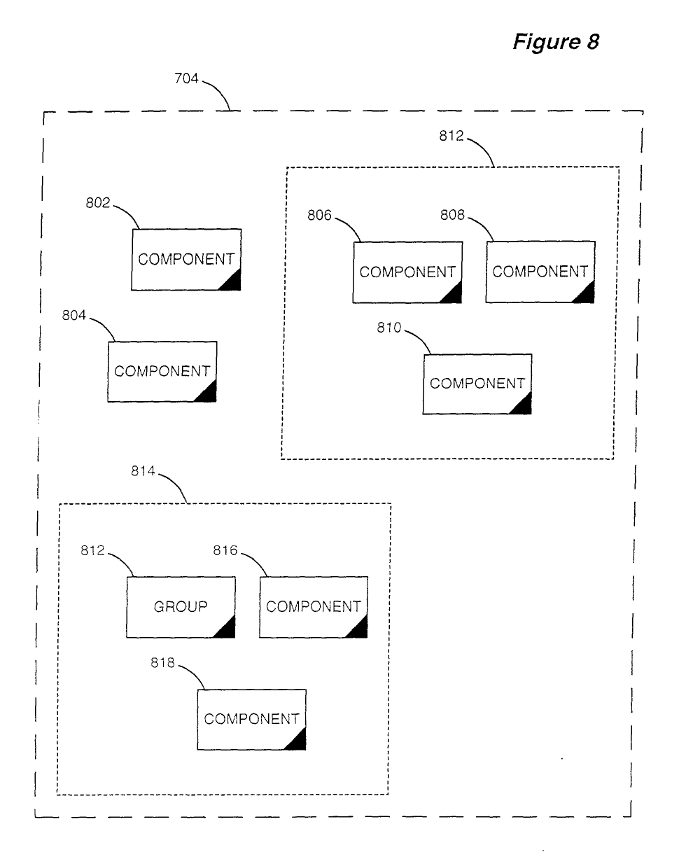

FIG. 8 comprises an illustration of the contents of a component repository according to an embodiment of the invention. Referring to FIG. 8, components repository 704 may comprises components 802-810, 816, and 818. These components are representative of textual or compensation components. Components repository 704 can also contain a group of components such as group 812. Group 812 contains components 806-810. A group can contain other groups. For example, group 814 may contain group 812 and components 816-818. Members of group 812 typically inherit behavior assigned to elements of group 814.

Relationship Definition

The user may group components together and specifies how the group of components interrelate (e.g., FIG. 2, step 212). Component-to-component relationships can be created between components within a document template. Relationships may be defined between a first set of components and a second set of components (e.g., compensation component X is related to textual component Y). When template processing is initiated (e.g., by the configuration engine) the relationship between the two sets is enforced on the components in the second set when all of the members of the first set of components are selected. In accordance with one embodiment of the invention, there are multiple types of relationships between components. For example, the user may associate each component with at least one of the following types of relationships: a requires, an includes, a can't work with (or excluded), and removes relationship. Once the relationship is defined the component may be categorized as a required component, optional component, or standard component. However, the designer may designate other rules that uniquely conform to the needs of the business for which the documents are generated.

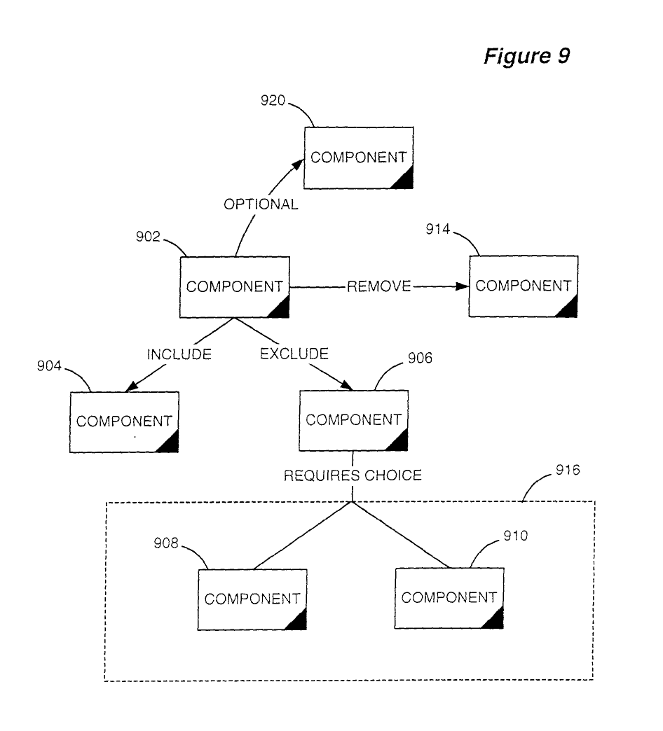

FIG. 3 shows groups of components the user has assembled. Each group comprises a document template with a set of components having defined relationships. Thus referring to FIG. 3, if the user grouped the set of components that comprise document template 302 the user specifies at step 212 the relationship between compensation components 306, 308, and 310n and textual components 312 and 316n. The relationship definitions identify how each of the components may contribute value to a generated document. In accordance with one embodiment of the invention a relationship is established for each of the components that make up the document template. These relationships (also referred to as rules) are therefore defined and later applied to groups of components. The rule sets for each group may be customized to reflect the underlying business logic associated with the document to be generated. One embodiment of the invention enables the user to associate one or more relationships with each component. FIG. 9 illustrates relationships between components according to an embodiment of the invention. All component types (e.g., standard, required, or optional may include or exclude other components.

A. Required Components

The requires choice relation recognizes that a choice (between a minimum and maximum number) has to be made between a second set of components (or members of a group) to ensure a valid configuration when the components in a first set are selected. Component 916 (e.g., identification of the parties to a contract) requires that a choice be made among components 908-910 (e.g., party A & party B). A requires choice relationship requires that a number of items be selected based on minimum and maximum values.

A required component therefore defines the minimum number of components needed to generate a document. When a required component is selected it may include or exclude other components. For example, if the document to be generated is a contract, the user may require that a component identifying the parties to the contract and a signature line be required. Other provisions of the contract such as those that ensure the document contains language supporting an offer, acceptance, and consideration may also be flagged as required components. The document designer (e.g., a lawyer or businessman) may indicate that certain other components that support the logical flow of the document also be given a required state. In accordance with one embodiment of the invention, the document designer may designate a minimum of at least one component as required. However, if the document is not required to be legally binding, more flexibility may be given and the system may not require that any number of components be specifically required. Whether a component is assigned a required is determined in one embodiment of the invention by the user. The decision is largely dependent upon the context of the business transaction the document is about.

C. Standard Components

In accordance with one embodiment of the invention, compensation components and textual components may also be defined as standard components. When a component is flagged as standard then that component is a standard part of every document generated using the document template that component is associated with. Standard components comprise groups of one or more components that are included or excluded from each other. Thus, standard components may be assigned an includes or an excludes relationship. For example, the user may designate components associated with provisions that are commonly contained in a contract as standard components. These designations may differ from one document template to another.

A textual component that is considered standard in one document template may be marked as required or optional in other templates. Standard components are flexibly integrated into the system so that the user can define the varying relationships that exist between the different components of a document. One component (e.g., textual components or compensation components) may be inclusively or exclusively related to other components. For example, if a component referred to as component X is to be included in a document the user may define a rule that disqualifies component Y (or a group of components) from being included in the same document. In other instances, the inclusion of component X might be defined to always allow for the inclusion of component Y (or a group of components). Other types of relationships can also be defined using rule sets. Thus, the use of rules provides the user with a mechanism to specify that any permutation of components in a document be defined as permissible or marked as impermissible.

For instance, referring to FIG. 9, component 902 may include component 904. In one embodiment of the invention, the includes relation causes a set of components in a second set (e.g., component 904) to be included in the configuration when a first set of components (e.g., component 902) is selected. For example, the sale of a term life insurance package may include contract terms related to that sale. Thus, when that life insurance policy is selected the appropriate terms will be included in the configuration.

The can't work with (or excluded) relation ensures that a set of components from a second set are never in the same configuration as components in the first set. For example, if compensation 902 represents a compensation component that pays the distributor 10% of every sale the can't work with relation may specify that a compensation component 406 that pays 20% of every sale cannot be selected. Thus, when component 902 is selected, component 906 cannot be selected. Component 906 is excluded such that it cannot be selected. Standard components may also be associated with a removes relation. For instance, when component 902 is selected, component 914 may be removed from the configuration. The removes relation causes items that are included in a second set of components to be removed from the configuration when the left side is selected. For example, when a compensation component associated with a high commission percentage is selected a compensation component that provides for a bonus if a certain number of items are sold may be removed from the configuration.

D. Optional Components

The user may also indicate that certain components are optional. Components 932 and 933 shown in FIG. 9 are optional components. When a component is assigned an optional state that component may or may not be included as part of a generated document. When an optional component is selected it may include or exclude other components. Thus, a minimum of zero or more optional components may be ultimately included as part of a generated document. If the document to be generated is a contract, some examples of the type of components that may be considered optional comprise addendum provisions that are not required to create a binding agreement. For example, a clause that provides additional compensation or rewards in the event that a distributor reaches a certain goal may not be necessary in order to create a binding agreement and could therefore be considered optional. In one embodiment of the invention, the user may set a minimum or maximum number of optional components. If, for example, the additional of another optional component would make the document longer than a required page length or some other arbitrary consideration, the user may configure the system to prevent more than a certain number of optional components from being selected. An optional component is not required for a valid configuration.

E. Component Groupings

As was briefly mentioned above, some components can be combined to form groups. Component groupings may exist at two levels. Within the document template, there can be explicit component groupings that arbitrarily defined by business rules. At rule definition time, the user can choose to arbitrarily group components for use in inclusion/exclusion rules. These groupings are implicit.

For example, components 908 and 910 can be combined to form group 916. Group 916 can be defined by the user. If the user does not define group 916, the invention preferably creates group 916 to contain components 908 and 910. Thus, when two or more components are defined on the right-hand side of a requires choice relationship, the invention preferably creates a group that contains these components. The requires choice then becomes a requires choice on the group (e.g., group 916).

Components are used to illustrate relationships in FIG. 9. However, a relationship can contain groups. To illustrate, a group of components can be substituted wherever a component is used in the illustration. Thus, for example, components 902, 904, 906, 908, 910, and 914 can each be replaced by a group of components. Thus, for example, if components 902 and 904 are replaced by groups (e.g., groups 902 and 904, respectively), when the members of group 902 are selected, the members in group 906 are included in the configuration. To further illustrate, component 908 can be replaced by group 908. In that instance, group 908 is a member of group 916. A hierarchy of groups (e.g., group 908 contained within group 916) can be used in a relationship.

Each grouping may form a document template. Components can be combined to form an arbitrary grouping. Thus, it is not necessary to combine components in a group based on a logical or intuitive relationship between the components in the group. The relations that are created between components within a product are enforced only on that particular product. However, if some component-to-component relationships are to be enforced on all documents within a certain document category, then the relations are created once and are enforced for all documents associated with a certain product. These relationships may be referred to as global relationships.

Template Processing

Once the interrelationships between each of the components comprising a document template are defined, those relationships are stored as rule sets to be processed by a configuration engine to form documents. If the user requests a document (e.g., at step 214), a document template is obtained from memory and utilized by the configuration engine to generate the requested document (e.g. at step 216). Each document includes zero or more elements of components repository 704 (see e.g., FIG. 7). Populating the document with the appropriate components obtained from the document template generates a document. The components within a document are classified as one of three different types: standard components (e.g., includes and excludes relations), required components, or optional components. A component that is not classified as one of these types is assumed to be unavailable in that document.

A. Configuration Engine

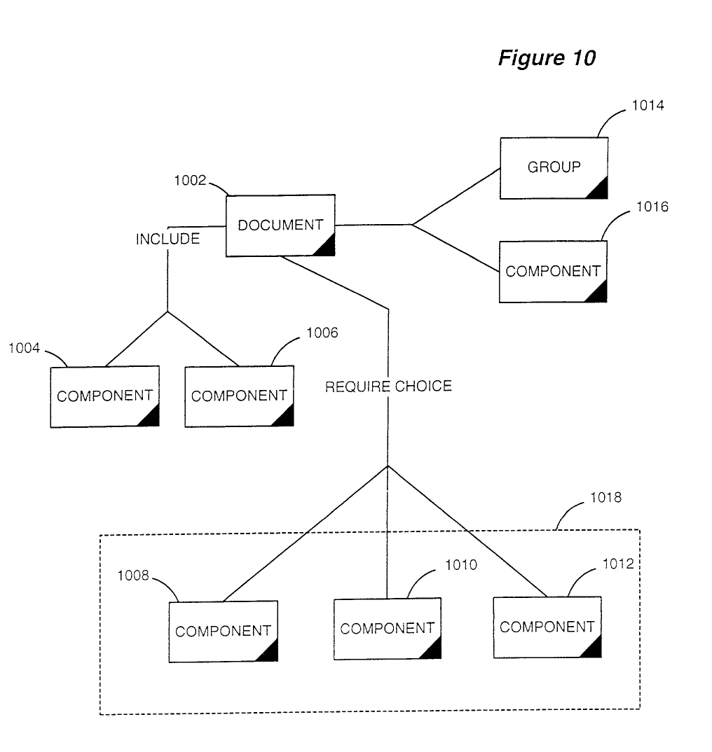

FIG. 10 provides an example of classification performed by the configuration engine according to an embodiment of the invention. When the configuration engine begins processing it applies the rules defined by the user and assembles the components need to generate the requested document. An included component is a component that is included in a document by default. For example, components 1004 and 1006 are automatically included in document 1002. For example, when a configuration user chooses the document template associated with document 1002, components 1004 and 1006 are automatically included in the configuration. A required choices classification specifies that a choice among a group of components must be made to create a valid document configuration. For example, components 1008, 1010, or 1012 must be selected to generate a valid document. An optional choice may or may not be included in the document generated by the configuration engine.

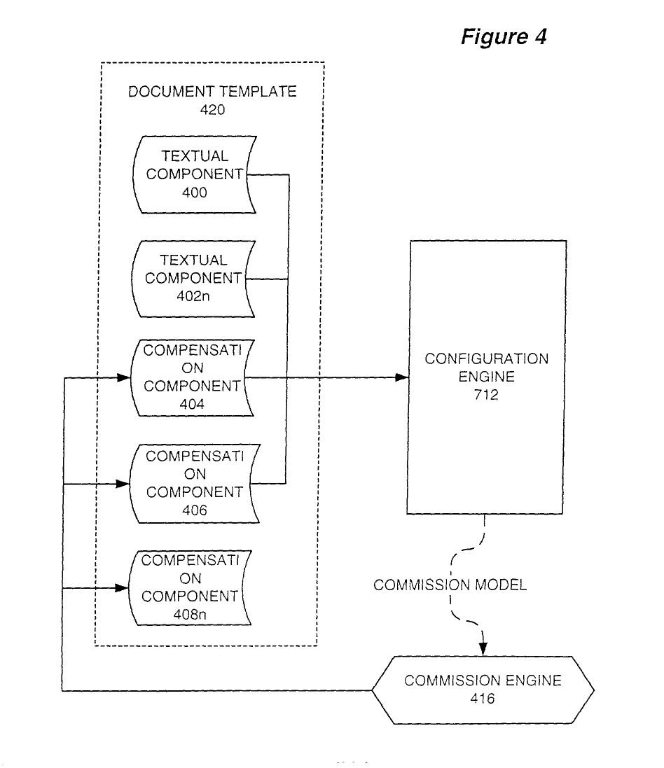

FIG. 4 shows the inputs to the configuration engine in accordance with one embodiment of the invention. In one embodiment of the invention, components (e.g., textual and compensation components) are representative of parts. The internal processes utilized by configuration engine 712 to process the document template and the relationships between components (e.g., parts) are described in further detail in U.S. Pat. No. 5,825,651, entitled “Method and Apparatus For Maintaining and Configuring System”, which in incorporated herein by reference.

Document template 420 comprises a set of components having interrelationships determined by the user. Compensation components 404, 406, and 408n are generated utilizing a commission model that may be output from commission engine 416. However, the reader should note that compensation components may also be independently defined utilizing a commission model independent of commission engine 416. Once formulated, the rules and interrelationships between each of the components are defined (e.g., components are indicated as required, optional, standard) and the document template is prepared for submission to configuration engine 712. In one embodiment of the invention, configuration engine 712 executes a document generator 710 which may apply the rule set defined by the user (e.g. at step 212) to generate a valid document. Thus, configuration engine 712 provides a mechanism for generating one or more documents from a repository of document templates stored in template repository 708.

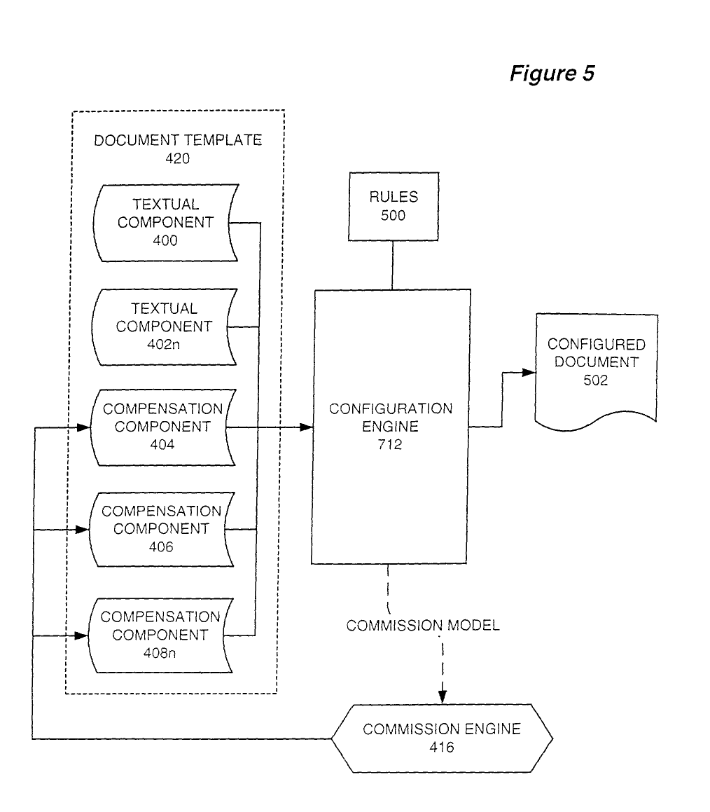

FIG. 5 comprises a block diagram illustrating the how an embodiment of the invention provides a document template to the configuration engine which is configured to apply a rule set and thereby generate a configured document. Configuration engine 712 utilizes the internal representation (e.g., rules 500 which represents the various component relations) associated with each document template to generate document 500 based on user input. Thus, an embodiment of the invention provides the user with the ability to specify a particular document. Once the user indicates which document is to be produced, configuration engine 712 verifies the document specification to ensure the document conforms to the rule sets 500 previously input into the system. The document is then provides to the operating user so that it can be printed or otherwise utilized for its intended purpose.

Customizing Selling Agreements

This section describes an example selling agreements package and its classes. The reader should note, however, that these class descriptions and the examples given are provided for illustrative purposes and that the invention contemplates embodiments that utilize other types of agreements or object models or computer programming techniques.

Selling Agreements Overview

Once implementation of the system designed in accordance with an embodiment of the invention relies on a set of agreements (Agreement objects), which are kinds of contracts. A selling agreement may detail the terms of compensation between a financial services company and a distributor that is selling its products. It is a contract that explains agreements established between financial services companies and their distributors. Typically, an agreement is with a distributor firm and includes a sales team hierarchy of the people that work for that firm. The flexibility of the system embodying the invention allows for a different commission model for each agreement.

Contract Kits

Agreements may be constructed from contract kits (ContractKit objects representative of document templates). Each contract kit contains a set of contract kit groups (e.g., ContractComponentGroup). A contract kit group classifies sets of contract kit components (e.g., ContractComponent).

Once the user has constructed a contract kit, the system submits it for approval to parties the user designates. The approval process allows for considerable flexibility at deployment time. The user can, for example, set up the system to automatically generate an email notification when an agreement is approved or denied. The user may perform this customization by writing code (e.g., Java) that causes system workflow triggers to fire, initiating the notification.

Compensation Components

A compensation component (e.g., CompensationComponent) is a specialization of the contract kit component class. CompensationComponent objects may deal specifically with distributor compensation. This object contains a reference to a template commission model that includes quota, eligibility ruleset, plan, bonus, and bonus rule objects. When the user creates an agreement, the user may make selections in the user interface to include some (or all) of the compensation components for a contract kit. Once selected, the template models of the compensation components are collected into a commission model referenced by the agreement (an Agreement object). The sales team hierarchy for the agreement model may be constructed from views of a party objects (representative of the parties).

Organizational hierarchies, such as sales teams hierarchies, are typically based on reporting structures within companies, but they might reflect an independent reporting hierarchy. Participation in plans is selected for each compensation component in an agreement. Agreements may be customized on an individual (Party) basis.

Independent Agreements

One of the elements of the invention's compensation is the ability for any distributor to participate in simultaneous contracts with one or more financial service companies. Contracts between parties are represented within the system as agreement objects. This flexible approach allows the same party (individual or organization) to be associated with many different agreements. In each agreement, the party is uniquely identified, remaining independent of any other agreements with which the party is associated.

For example, in one agreement a distributor named Bud may be compensated for selling traditional life policies. In a second agreement, Bud may be compensated for selling a variable life product. Bud's compensation from one agreement is independent of his compensation from the other agreement. This independence is maintained in the system by agreement relationship objects. In the previous example, Bud has two different agreement relationships. The system also maintains personal information about Bud (like his address) that is separate from his agreement relationships.

Shared Compensation

The way credit is given in one distributor agreement may be independent of how it is given in another agreement. For example, suppose Pete also gets credit (through roll-up) when Bud sells a variable life policy in his first agreement. Suppose, too, that Stu gets credit when Bud sells a traditional life product through his second agreement. Because agreement relationships are independent of one another, Stu will not get any credit when Bud sells a variable life policy through his first agreement.

Interdependent Agreements

Even though agreements can be independent of one another, there may be times when one agreement depends on another one. Business submitted for one agreement also may be accounted for in a second agreement. For example, suppose an account manager agreement type allows a financial services account manager to be compensated on all the business submitted by his distributor firms (accounts). Each of these firms has a unique agreement with the financial services company and yet the account manager compensation includes all the business done with the firms tied to his account manager agreements.

Sample Agreements

The following sections analyze a set of sample agreements to illustrate how the system deals with sharing distributors across multiple agreements. Agreements are illustrated in the diagrams with boxes that contain an ID like A1 or A2. Agreement relationships are illustrated in the diagrams with circles that include the name of the distributor and an ID number to reflect an association to an agreement relationship. The agreement names and compensation plans are examples of the types of agreements that may be constructed with the system software.

BGA Selling Agreement

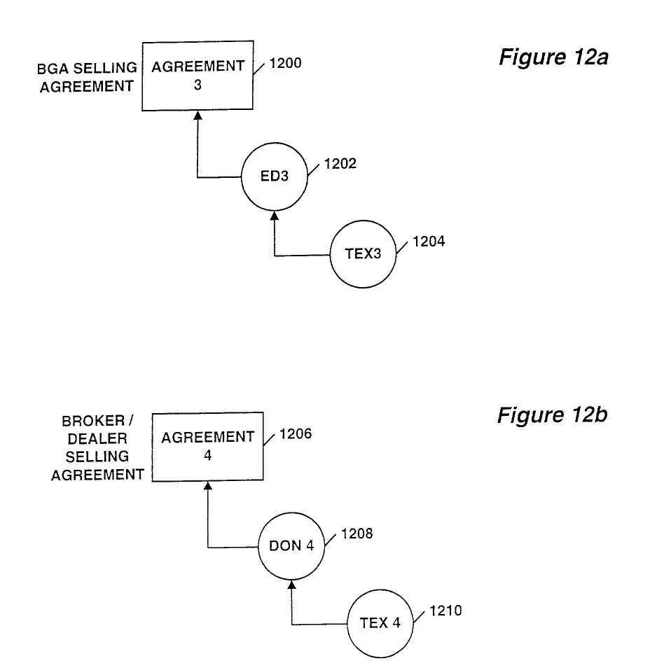

For the first example, assume two different agreements have been created and that one distributor, named Tex, is a member of both agreements. These agreements are illustrated in FIG. 12a (a BGA selling agreement). See the diagram pictured later in this section. The first agreement is the BGA Selling Agreement with a distributor named Ed. In the diagram, the agreement is labeled as A3. The agreement has been created with distributor Ed, identified in the diagram as Ed3 (e.g., block 1202) because Ed is included in Agreement 3 (e.g., block 1200). Tex is identified as a sub-producer in the agreement hierarchy where roll-up credit goes to Ed. Because of his relationship to Agreement 3 (e.g., block 1200), Tex is labeled Tex3 (e.g., block 1204) in the diagram. The selling agreement in this example may specify that Ed will be paid 45% of first year target on all business closed by his sub-producers, and the sub-producers will be paid 50%.

Broker/Dealer Selling Agreement

The agreement illustrated in FIG. 12b is a Broker/Dealer Selling Agreement with a distributor named Don. Broker/Dealer Don is labeled in Agreement 4 (e.g., block 1206) as Don4 (e.g., block 1208). Tex is also in this agreement and is labeled in the diagram as Tex4 (e.g., block 1210). Credit given to Tex4 (e.g., block 1210) rolls up as credit to Don4 (e.g., block 1208). The selling agreement specifies that Don will be paid 80% of the first year target on all business from the reps involved in the agreement. The agreement further specifies that the reps (in this instance, Tex) are paid nothing.

Agreement 3 (e.g., block 1200) does not include Ed as a registered Broker/Dealer. According to this agreement, he is only able to solicit traditional products. Therefore if Tex wants to sell variable products, the business is submitted through his broker/dealer agreement with Don. With Ed, Tex can only sell traditional products. When Tex sells traditional products, Don is not involved and therefore receives no credit.

Admin Services Agreement

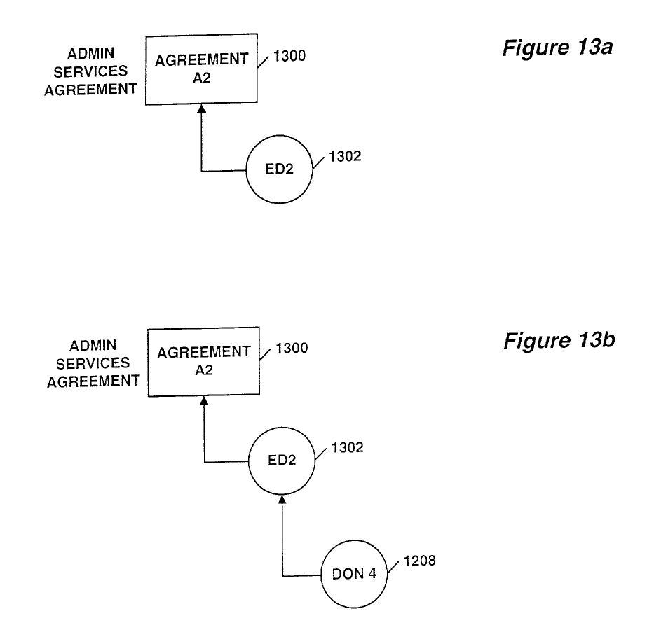

Referring now to FIG. 13a, although the BGA (Ed in this example) may not be a broker/dealer, there are times when Ed may facilitate the selling of variable life policies by Tex. To allow for this situation, a separate agreement is created with the BGA so that they may be appropriately compensated. This agreement (in the current example called an Admin Services Agreement), specifies that Ed will be paid 15% of first year target on all business from Don's reps. This compensation applies only to the business that comes through Don's office for packaging the case (that is, providing sales support). This agreement is appears in the diagram below as A2 (e.g., block 1300) and the BGA may be identified uniquely in this agreement as Ed2 (e.g., block 1302).

For the type of agreement represented by A2, the business submitted through the Broker/Dealer in Agreement 4 (e.g., block 1206) may OR may not be ‘packaged’ by the BGA, but when it is, the user want Ed in Agreement 2 to be given credit. There are a couple of ways this can be accomplished. The first would be to add a reference to Don in Agreement 4 (e.g., block 1206) to the agreement hierarchy.

Through this agreement hierarchy, when business is credited to Don in Agreement 4 (e.g., block 1206), then Ed in Agreement 2 will also get credit. However, because Ed should only get credit when he has facilitated the transaction, the reference to Don4 (See e.g., block 1208 of FIG. 13b) may be constrained through a rule that selects only some of the transactions credited to Don in Agreement 4 (e.g., block 1206). That is, it should only include those transactions that indicate Ed provided sales support.

Additional Agreements

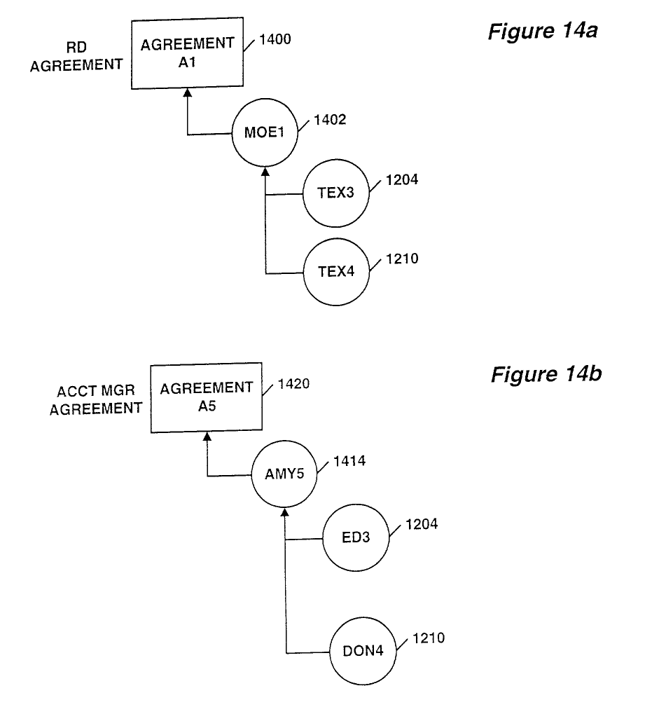

Embodiments of the invention may also be adapted to handle additional types of agreements such as those illustrated in FIG. 14a. For example, the system may generate a Regional Director Agreement and an Account Manager Agreement. The first is identified as Agreement 1 (Al) (e.g., block 1400) in the following diagram. Moe1 (e.g., block 1402) identifies the regional director in this agreement. The regional director is compensated based on business solicited by distributors in many other agreements. The agreement specifies that he will be paid 6% of first year target on all direct Broker/Dealer business through his office, 5% on all business through a BGA, and 1% on Broker/Dealer business that goes through the BGA. Since the regional director compensation rewards Moe for sales support, he may receive less on the business that is also supported by BGA.

Agreement 5 (A5) (e.g., block 1420: FIG. 14b) block in the following diagram. Amy5 (e.g., block 1414) is the account manager. The account manager agreement hierarchy includes an entire firm and the account manager will be compensated based on 1% of all their associated business.

Transactions in the Sample Agreements

The following section provides a sample set of transactions involving the distributor Tex and based on the agreements illustrated in FIGS. 12-14). First the user will find a description of the desired result of the sample transactions and then an account of how the system software achieves this result. Assume that Tex submits the following set of transactions:

1. A variable life product through the broker/dealer.

2. A variable life product that has been packaged through the BGA office.

3. A traditional life policy through the BGA office.

Note: The second transaction is submitted through the broker/dealer, but the transaction indicates that BGA provided sales support.

Compensation in Sample Agreements

The following table shows which distributors are compensated based on the compensation elements of the agreements in the examples. The shading highlights the effect of an agreement.

| | Party | Based- | Party | Based- | Party | Based- | Party | Based- | Party | Based- |
|---|---|---|---|---|---|---|---|---|---|---|
| Case | A | on | B | on | C | on | D | on | E | on |
| 1 | | | | | 0 | n/a | 6% | Agmt 1 | 1% | Agmt 5 |
| 2 | | | | | 15% | Agmt 2 | 1% | Agmt 1 | 1% | Agmt 5 |
| 3 | 50% | Agmt 3 | 0 | n/a | 45% | Agmt 3 | 5% | Agmt 1 | 1% | Agmt 5 |

The system software configured in accordance with an embodiment of the invention may distribute compensation for Cases 1, 2, and 3 through five different agreement objects and five different contract kits. Each of the contract kits defines compensation components specifying the performance measures and plan elements of the agreements. The compensation components indicate, for example, that Tex gets 50% on a traditional policy, like the one sold in the third transaction. The agreement objects are created from the contract kits. Each of the distributors in this example has an associated party object (e.g., Party). Party objects are used to maintain all of the information about a distributor that is independent of agreements.

The user may associate party objects with an agreement by adding them to an agreement allocation hierarchy. For every party added to an agreement in this way, the system creates an object called an Agreement Relationship object (e.g., AgreementRelationship). The agreement relationship object maps the party to an agreement and a sales team member (AgreementParticipant, a derivative of the Person object). When the system creates an agreement relationship, it assigns a unique ID called the Agreement Relationship ID (the Unid property of the AgreementRelationship). (The system may provide a default method for determining the ID, but the user can override the default.) The Agreement Relationship ID appears on input transactions to uniquely identify the distributor and a specific agreement. The following explanation covers the way in which the system configured in accordance with an embodiment of the invention processes the transactions (cases 1-3) described above. In order to cover the processing, the explanation takes up at the point after the agreement objects have already been created.

Transaction Processing

When an agreement object is constructed, it may include a reference to a commission model object (e.g., CMModel). For the agreements described above, there are five commission model objects. Each commission model object for an agreement refers to a specific sales team hierarchy. The hierarchies are illustrated in the preceding agreement diagrams. The system assumes there is a custom transaction loader program that creates Transaction objects for use as input to the commission engine. The transaction objects indicate who sold what to whom and identify the appropriate agreements. For the system, input transactions refer to an Agreement Relationship ID in order to indicate who is involved and for what agreement. The Agreement Relationship ID is a customizable string value assigned to every agreement relationship. In this example, the Agreement Relationship ID is made to be readable but unique.

| Transaction 1 | Transaction 2 | Transaction 3 |
|---|---|---|
| AgentCode=TexA4 | AgentCode=TexA4 | AgentCode=TexA3 |
| Product=Variable | Product=Variable | Product=Traditional |
| Packaged: n/a | Packaged: by Ed in A2 | Packaged: n/a |

To process the input transactions, the system provides a commission engine preprocessor, referred to as the DMS engine. The DMS engine evaluates all input transactions (in batches until all available have been processed) and for each associates an agreement object and sales team member. It also identifies any other agreement objects affected by the input transaction. When it finds an affected agreement object, it creates additional transactions that process compensation according to the newly-identified agreement commission models. Once all input transactions have been associated with agreements, the DMS engine invokes the commission engine. (e.g., accumulate, compensate) on agreement models.

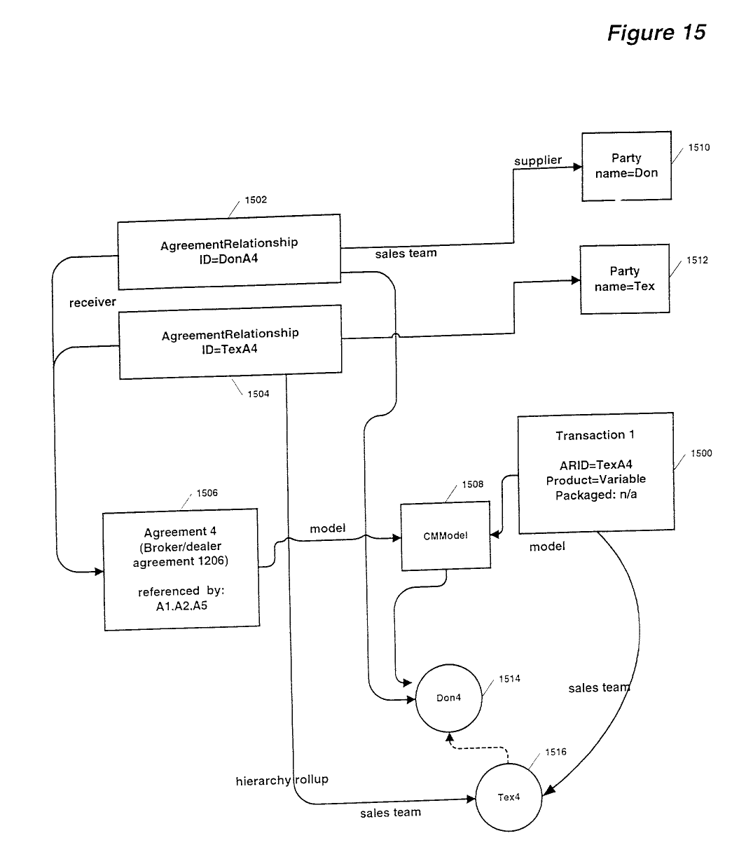

The effect of the first sample transaction on Agreement 4 (e.g., block 1206) is shown in the object instance diagram illustrated at FIG. 15. The ID on the transaction (e.g., transaction 1 at block 1500) is used to identify the AgreementRelationship (e.g., block 1502/1504) related to the party or parties submitting the business (Don and Tex). The AgreementRelationship object provides access to the agreement (A4), (e.g., at block 1506) the commission model (CMModel, e.g., at block 1508) referenced by the agreement, the sales team member object and the Party objects (e.g., at blocks 1510/1512: for Don and Tex).

Based on the input ID information, the system modifies the transaction model and sales team properties. The transaction is actually represented in the object model by a pair of objects: (e.g., a Transaction object and a CMTransaction object), but may also be represented in other ways. As a result of references to Agreement 4 (e.g., block 1206) relationships, the transaction processing affects three other agreements in this example. The referencing agreement relationships for Agreements 1, 2, and 5 may be referred to as: TexA1, DonA2 and TexA5.

Transaction Rules

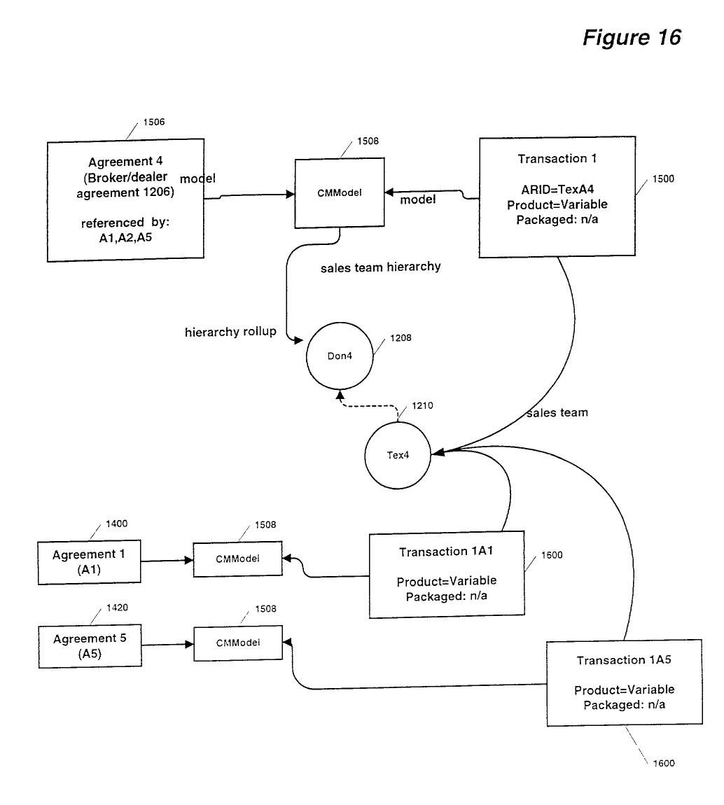

In processing transactions, if the system encounters an agreement-to-agreement reference (a link), it is a signal that the input (e.g., CMTransaction) for the agreement commission model is to be duplicated and associated with the other related agreement commission models. As discussed in associations with Agreement 2, not all transactions credited to Don in Agreement 4 (e.g., block 1206) should also be credited to Ed in Agreement 2. Only those transactions for which Ed has been identified as the packager should be credited to Ed. A rule should also be defined to ensure that only the appropriate transactions are credited to Ed. In one embodiment of the invention, this is referred to as a Transaction Rule. Therefore, the user may create a Transaction Rule (e.g., T.PackagedBy=‘Ed’) to ensure that Ed gets credit on only those Agreement 4 (e.g., block 1206) transactions that Ed was associated with. With such a rule in place, the transaction rules may result in the following new transactions illustrated in FIG. 16.

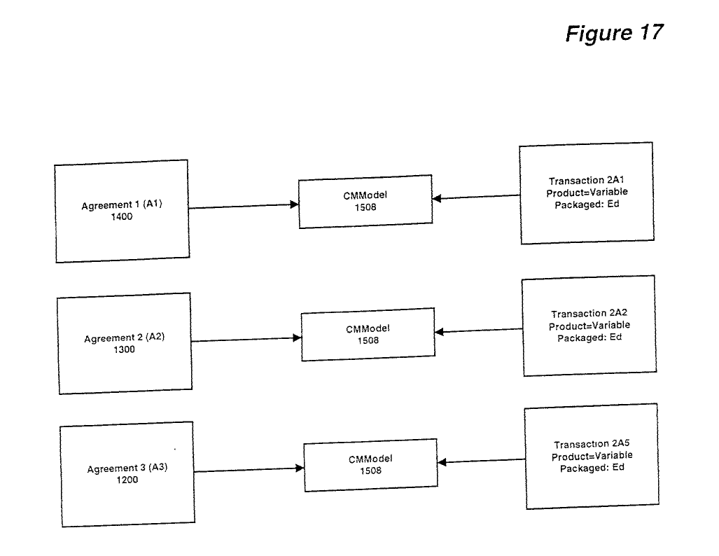

When the second sample transaction is processed in the same way, the resulting set of transactions would differ because the packager has been identified as Ed. An additional transaction for the Agreement 2 model would be created as illustrated in FIG. 17. Transaction rules such as the one described above are defined in the system contract kit maintenance tool and may be stored in the TransRules property of a contract kit object. They are available to be selected for a party.

Global Transaction Rules

In some cases, like the Admin Services Agreement described earlier (Agreement 2), the user may find it inconvenient to include all the parties required in the Agreement 2 hierarchy in order to assign correct credit to Ed. To simplify the process, the system may provide for Global Transaction Rules. Global transaction rules are evaluated on all preprocessed transactions, regardless of the party on the incoming transaction. For example, a global transaction rule for Agreement 2 can be set up identifying Ed as a recipient. The user can use the same rule created earlier (T.PackagedBy=‘Ed’). With this rule in place, the Agreement 2 hierarchy would include only Ed:

With the Admin Services Agreement hierarchy and the global rule, the results of the input transactions would be the same. The last sample Transaction (3) is based on a traditional life product sold by Tex in Agreement 3 (e.g., block 1200). Tex's agreement relationship in Agreement 3 (e.g., block 1200) is referenced by Agreements 1 and 5. Just as additional transactions were created for the previous transactions, Transactions 3A1 and 3A5 would be created in response to Transaction 3.

In one embodiment of the invention it is not uncommon to have producers represented under more than one sales manager agreements and depending on the product sold, the rollup would only go to the sales manager agreement that is identified for that product. For example, if Agreement 1 specified variable products only, then we would need an additional transaction rule (for example, T.Product=‘Variable’) that would inhibit the creation of some transactions for Agreement 1.

Customizing the Selling Agreements Module

When deploying system embodying the invention, the user may want to customize the way in which IDs are generated in the Selling Agreements module. In this module, the genUnid Backbone method provides a default implementation. This method generates unique IDs when two Selling Agreement classes, Agreement and AgreementRelationship, are created.

The user may find that the unique ID generated by the default implementation of genUnid is not appropriate to the user deployment. Override this Backbone method on one or both of the classes to customize to the user company's business requirements. But when customizing generated IDs, be sure to avoid ID conflicts among hierarchies. Sales team hierarchies share their Unids with the agreement that owns them.

Selling Agreement API

The following section identifies and describes the classes in the Selling Agreement Package in accordance with one embodiment of the invention. The reader should note, however, that these class descriptions and the examples given above are provided for illustrative purposes and that the invention contemplates embodiments that utilize other object models or computer programming techniques.

ContractKit

A contract kit is a type of container for contract components. It is the top-level object of a collection of objects that define a specific type of contract. Generally, an object corresponds to a type of base contract. For example, a Broker/Dealer contract kit would most likely be independent of a contract kit for a general agent.

Properties and Methods

A contract kit is a subclass of DataObject. All DataObjects have a name and a description property.

Name: The name of the kit.

Description: The description of the kit.

MajorVersion: A short integer containing the major version number of the contract kit.

MinorVersion: A short integer containing the minor version number of the contract kit.

Source: The source is the contract kit from which this one originated. For a new contract kit, the source is a self-pointer.

Predecessor: The predecessor is the previous version of this contract kit. For a new contract kit, the predecessor is a self-pointer. The predecessor pointers form a linked list of the history of the contract kit.

Party: Contract kits are associated with an Party object in the system. When an agreement is created at run time, two parties are identified. One of those arties (the agreement provider) determines which of the available contract kits the other party in the agreement may select. For example, for a General Agent contract kit, the party property would identify the financial services company that is offering the contract.

Components: Components is a linked collection of ContractComponent objects. The ContractKit components collection may only contain ContractComponentGroup objects. (A subclass of ContractComponent.)

ContractType: The ContractType is an integer value that identifies the type of contract that this kit represents. The value of this property may only be one of the values defined by the Contract Inventory List for the party identified for this kit.

Products: A link to an Hierarchy of CMProduct objects. For a selling agreement, this hierarchy defines the products that may be sold through this contract.

AllocDefault: Specifies that default allocation should be set on models created from this kit. This property is simply copied to all models generated from this kit.

AllocDefaultRollup: Specifies that default allocation rollup should be set on models created from this kit. This property is simply copied to all models generated from this kit.

Approver: The User that approved the contract kit.

Approved: A Boolean property specifying whether this contract kit is approved.

ConfigModelXML: A BLOB (Binary Large Object) property that represents the XML for the CommerceConfig model capturing the selection rules for this contract kit.

GetVersionString: Returns a version number as a string.

GetAssociatedAgreements: Returns an enumeration of the agreements that use this contract kit.

GetEffectiveDates: Returns an enumeration of DateRange objects that identify the periods of time when the contract kit is effective. Use this method to get effective periods. There are no explicit start/end date properties.

ContractComponent

The contract component is the base class of the components contained within a contract kit.

Properties

Report: The Report for this component. The report defines what is printed/displayed for this component.

MajorVersion: A short integer containing the major version number of the component.

MinorVersion: A short integer containing the minor version number of the component.

Source: The source is the component from which this one originated. For a new component, the source is a self-pointer.

Predecessor: The predecessor is the previous version of this component. For a new component, the predecessor is a self-pointer. The predecessor pointers form a linked list of the history of the component.

RelatedKit: The contract kit that this component has been bound to. RelatedKit is only used when the component is part of an agreement. As a template, a component may be used with a variety of kits.

Customizations: An owned collection of Customization objects for this component, if any.

Methods

GetVersionString: Returns a version number as a string.

GetAssociatedKits: Returns an enumeration of the kits that use this contract component.

GetAssociatedGroups: Return an enumeration of the groups that use this contract component.

GetEffectiveDates: Returns an enumeration of DateRange objects that identify the periods of time when the component is effective.

ContractComponentGroup

This class is a subclass of the ContractComponent class. A component group contains a set of related contract components. ContractKit objects contain ContractComponentGroup objects. A component group never contains another component group.

Properties

Components: A linked collection of ContractComponent objects contained by this group.

MajorVersion: A short integer containing the major version number of the component group.

MinorVersion: A short integer containing the minor version number of the component group.

Source: The source is the component group from which this one originated. For a new component group, the source is a self-pointer.

Predecessor: The predecessor is the previous version of this component. For a new component, the predecessor is a self-pointer. The predecessor pointers form a linked list of the history of the component.

CompensationComponent

This class is a subclass of ContractComponent. It is used as a template for a commission model.

Properties

Model: A template commission model. This model defines a set of quotas and plans. When selected at run time, the objects defined in this template model are cloned and assigned to a commission model.

Customization

With the system embodying the invention, the user can customized pre-defined commission models during the negotiation of an agreement. For example, perhaps the user want the starting value of a quota level to allow for changes within a specific range of values. DMS provides for this through an Customization object. An Customization object is a specification for an affected object (in this instance, the quota level). A contract component (ContractComponent) contains a collection of Customization objects. It is possible, through the use of customization objects, to allow for several customizations to be made to the commission model for a compensation component. The Customization class has two object properties for indicating what the affected object property is. One of these is called simply the AffectedObject, used to directly specify the affected object of the customization. The AffectedProperty is a string that specifies the property name on the affected object. DMS user interface employs the AffectedObject and AffectedProperty at run time to get and set the customized value. The other key Customization object property is called the OwningObject and is for locating the affected object within the commission model (or whatever framework is being customized). The owning object has an object path associated with it. The path specifies how to get from the owning object to the affected object. These values are used in maintenance tools that manipulate the Customization object to know how the affected object relates to others in the commission framework.

Customization Types

There are several Customization types. They are listed and described in the following table:

| Customization | | Allowed Values: name/value |
|---|---|---|
| Type | Description | attribute pairs |
| Simple property | Uses the affected property | n/a |
| | type. Any value of that type | |
| | may be placed in the | |
| | property. | |
| Min/max range | Sets a minimum and | min=<minimum_numeric_value> |
| | maximum | max=<maximum_numeric_value> |
| | allowed value for the | Where −1 indicates any value |
| | affected | |
| | property. | |
| Enumeration | Gives a list of the allowed | enumCount=<#_of_values> |
| | values. | enum1=<value> |
| | | enum2=<value> |
| | | enumN=<value> |
| | | Where “N” = <#_of_values> |
| Substitution | Substitutes a value into a | Template=<pattern_string> |
| | string property. For | Where <pattern_string> may |
| | example: to prompt the user | include: |
| | with a single text entry field | {iVARNAME} for integer variable |
| | for a number, and have the | {sVARNAME} for string variable |
| | value inserted into a | {dVARNAME} for double variable |
| | formula, the user would set | {fVARNAME} for float |
| | the template attribute value to | {SVARNAME} for short |
| | the formula with the | |
| | {dVARNAME} tags inserted | |
| | into them. The value the | |
| | user enters will be inserted | |
| | into this spot. | |

Customization objects appear as entry fields or drop-down lists in the user interface. Changes made in the user interface apply to the customization's underlying affected object. In some cases, the value for a customization will depend on the value given for another customization. Two customizations available in the DMS software use the object model slightly differently. These are Sales Team and Quota State customizations. These customizations allow the user to change individual sales team members and their quota states. The user use the Individual Type property of Customization to specify these customizations. Individual Type has three possible values:

Component Level: These customizations are made at the component level. They apply to all participants in that component.

Sales Team Level: These customizations are made to a sales team member. They can be set to different values for each sales team member.

Quota State Level: These customizations are made to a sales team's quota state. They can be set to different values for each quota period and sales team member.

Unlike other customizations, the sales team level and quota state level customizations do not use the following properties: OwningObject, ObjectPath, AffectedObject, and AffectedProperty. In fact, they do not update the commission model itself. They update attributes on the sales team object (AgreementParticipant) or the quota state object (CMQuotaState). When the user create a sales team or quota state customization, it allows the user to set an attribute named VarName on a sales team or quota state object from the party/agreement. This attribute can be used in formulas within the compensation component. For example, say the user create a SalesTeam customization called SalesTeamPathe usertRate. Then, in a bonus rule the user could use the formula:

Performance*getSalesTeam( ).GetCustomization(‘SalesTeamPathe usertRate’, 0.5)

The method GetCustomization is defined on both CMQuotaState and AgreementParticipant. The first parameter is the variable name of the customization. The second parameter is the default value to use if the customization is not set. Thus, at run time, if the customization has not been set to the sales team member, the formula would evaluate to Performance * 0.5, otherwise it would evaluate to Performance *(the customized value).

Properties

VariableName: The variable name string bound to a customized report. When building a report for a contract kit component, refer to the component using this variable. End users do not see this variable name unless they are building a report.

CustomizationType: An integer value that is a bit vector. It records the type of customization. (See the customization table earlier in this section.)

IndividualType: An integer value specifying component level, sales team level, or quotastate level.

AffectedObject: The AffectedObject is the Backbone object that will be changed through customization. Typically, the affected object will be an object in a commission model.

AffectedProperty: The AffectedProperty is the property name of the AffectedObject that will be modified by this customization object.

OwningObject: OwningObject is a reference to a Backbone object and is for locating the affected object within the commission model (or whatever framework is being customized).

ObjectPath: A deep property path string that specifies how to get from the owning object to the affected object.

AllowedValues: An Attributes collection of name/value pairs. (See the customization table earlier in this section.)

Component: A backpointer to the contract component that contains the owned customization object.

Constraints: A collection of CustomizationConstraint objects.

Methods

SetValue: A method for setting the value of the affected property. The type of the given value must be of the same type as the property being set. Any constraints in the constraints collection are evaluated in response to setting the value.

GetValue: Returns the value of the affected property.

CustomizationConstraint

Customization may contain a set of constraints (CustomizationConstraint objects). The constraints are formulas (Formula) that are evaluated when the value of the customization is set with the SetValue method. Evaluation is in the order in which they were inserted into the customization's collection of constraints. A constraint formula may refer to any component customization objects by the assigned variable name. For example, if there were two customizations on a component—one named end for the end value of one quota level and one named start for the start value of a second quota level—each could be set up with a constraint formula as follows:

1. start=end+1

2. end=start−1

Properties

TargetName: The variable name of a customization object in related Component.

Constraint: The constraint as an Formula.

Agreement

The Agreement object represents a specific instance of a contract between two parties. It is typically created from a contract kit. Whether or not to use a contract kit depends on the type of agreement.

Properties

Unid: A unique ID for the agreement.

AgreementParty: The primary party that has accepted the terms of the agreement.

AgreementProvider: The primary party that is providing the terms of the agreement.

Approver: The User that approved this agreement.

PublicityStatus: A Boolean value indicating whether this agreement may be publicly acknowledged.

StartDate: The date the agreement became effective.

EndDate: The date the agreement became ineffective.

Model: For a selling agreement, the model property specifies the commission model that contains the agreed upon compensation plans. When an agreement is created, the template commission models associated with any compensation components that have been selected are cloned and assigned to this agreement commission model.

ContractKit: The contract kit property of an agreement refers to the contract kit that was used to create this agreement.

Components: The components property is an owned collection of the cloned ContractComponent objects that were selected during the construction of the agreement.

AgreementType: The type of the agreement determines the role of the parties associated with this agreement.

Methods

OnCreate: An event method called when the agreement is created. Sets the initial status of the agreement. Override this method to change the setting of the initial state of the agreement.

SetStatus: Sets the current status of the agreement. Specify the status type name and status value as arguments. The status type is an enumerated list name. The value of the status is an integer value.

GetStatus: Gets the current status of the agreement. A status type name is given and an integer is returned. The returned integer corresponds to an enumerated list value.

OnStatuhange: Whenever the status of the agreement is set, this event method is invoked. It indicates the status is about to change to the given state. By default, this method will react by setting the end date on all current state. Returns true, indicating the user can make the change, or false, indicating the current state remains unchanged and the user cannot change to the new state.

FormatDate: A convenience method available to Report formula writers when this agreement is a Report variable.

GetGroupDocumentsByName: A convenience method available to Report formula writers. Returns a collection of the named component group's documents.

GetGroupDocuments: Returns a collection of the given component group's documents.

GenerateDocuments: Using the Report objects of contained contract components and the Report engine, generates reports for this agreement. GetDocuments may access the generated documents.

GetDocuments: Returns a collection of Document objects generated by GenerateDocuments.

GenerateDocument: Generates a document for the given contained contract component.

GetVariableBinding: A callback method to be implemented by report writers to bind custom variables. It is called to bind a report variable to a value. Given a variable name, the method returns an object that corresponds to that variable. It returns null if there is no binding. The default implementation does not know anything about custom variables, so it always returns null.

GenUnid: Generates a unique ID (the Unid property) for this agreement. Override to customize the generated ID.

AgreementRelationship

Whenever a party is added into an agreement hierarchy, the system creates an AgreementRelationship object. The Relation object is created with a supplier and receiver property that define a mapping between an Agreement object and a party. The Relation property for relationdata refers to an instance of AgreementRelationship. The AgreementRelationship is the place where agreement-specific data is stored for a party. This includes specific payment definitions and individual agreement customizations for the distributor. It also includes the associated party's contact point to be used for this agreement.

Properties

Unid: The unique ID of the agreement relationship. This uniquely identifies the distributor in the agreement.

FinInfo: A collection of FinancialInfo objects that define this party's agreement-specific payment selections.

Components: A collection of ContractComponent objects that define this party's agreement-specific customizations to the contract compensation components of the agreement.

Salesteam: The AgreementParticipant object (derivative of Person). The refers directly to a member of a sales team hierarchy in a commission model that is associated with the related Agreement.

Contact: The party's contact point object to be used by the party in this agreement. If not specified, use the party's primary contact point.

AgreementParticipant

The Agreement Participant class is a subclass of the stock Person class. Instances of agreement participants are used as sales team members in an agreement's underlying Commission model. These objects identify a party's position in the agreement's sales team hierarchy and identify a party as a participant in bonus plans.

AgreementParticipant and OMS Integration

The Agreement Participant class is a subclass of the stock Person class. Instances of an agreement participant are created while adding parties to an agreement's sales team hierarchy. AgreementParticipants shell salesteams—the real information, such as contact points, payment methods, and licensing and appointment for the producer, is stored on the Party. Party is indirectly tied to its AgreementParticipants through AgreementRelationships. (There can be more than one agreement participant object for each party object.) The normal Person fields, such as Address, are not filled in on AgreementParticipant instances, with the exception of Name (which matches the party's name). The Opportunity Manager System (OMS) shows all Persons. Since there could potentially be a large number of what would appear to be duplicate Persons in OMS, DMS uses a subclass of Person rather than using the actual Person class. Instances in the commission sales team hierarchies avoid the problem of these fake sales teams showing up in OMS. OMS explicitly filters out subclasses in its query for sales teams (which are represented by Person instances, not instances of Person subclasses).

Pooling Object Model

A pooling agreement is represented by an Agreement object and will have its AgreementType property set to PoolingAgeement. The additional information needed for the pooling agreement is stored in the PoolingAgreement object, which is a property on Agreement.

Pooling Agreement

A pooling agreement is a special kind of agreement that combines quotas and compensation. It could be set up to combine compensation for two or more parties. Or it could combine compensation from two different agreements set up for one party. The pooling agreement is made up of the following:

Agreements—A back-pointer to the Agreement object.

Participants—A collection of PoolingAgreementParticipants

Relations—A collection of PoolingRelations

Quotas—A collection of quotas that are pooled in this pooling agreement.

The Agreement object also stores the components that are pooled in the pooling agreement (the pooled quotas belong to these components). There is also a Relation for each party in the pooling agreement.

PoolingRelation

The members of a pooling agreement are agreement relations (since the user pool work from parties in a particular agreement). The PoolingRelation represents these members.

Properties

Relation: The Relation object for the agreement relation.

Source: A Boolean specifying if this member is a source in the pooling agreement

Target: A Boolean specifying if this member is a target in the pooling agreement (each member must be at least a target or a source).

Agreement: A back pointer to the Agreement object.

PoolingParticipant

This object specifies a member (PoolingRelation) and a quota to be pooled. For each member and each quota, there is a participant specified on an PoolingAgreement object. There are start and end dates for each participant.

Properties

Participant: The AgreementParticipant object from the agreement being pooled.

Quota: The CMQuota object from the selling agreement's model. This quota is based on the template quota and the agreement relationship.

Source: A Boolean specifying if this member is a source in the pooling agreement (each member must be at least a target or a source).

SourceStartDate: A date specifying when the participant starts being a source for pooling.

SourceEndDate: A date specifying when the participant ends being a source for pooling.

Target: A Boolean specifying if this member is a target in the pooling agreement (each member must be at least a target or a source).

TargetStartDate: A date specifying when the participant starts being a target for pooling.

TargetEndDate: A date specifying when the participant ends being a target for pooling.

Engine Transaction Processing

When the DMS engine processes input, the input transaction must identify a specific agreement relationship (AR) object. That relationship identifies at least one Agreement object that the transaction applies to; however, there may be other agreements for which the input transaction should also apply. These other, related agreements are determined by links (references) to the agreement relationship specified for the input transaction. The system identifies and manages such links in two phases, a preprocess and a process phase.

Preprocessing Phase

The engine's first phase is the transaction preprocessor (see preprocess( ) method of the DMS engine). The transaction preprocessor loops over a set of unprocessed Transaction/CMTransaction pairs and determines whether these input transactions apply to any agreements other than the one identified by the Transaction. If the transactions do apply to other transactions, additional CMTransaction objects are created and associated with the input Transaction with a back-pointer. The DMS system assumes that the SalesTeam and Model properties of the input CMTransaction are not identified as engine input by the transaction loader. During this initial phase, the set of affected agreements is determined. This set provides input to the next phase of the DMS Engine (see the process method of DMS engine). The agreement processor evaluates each affected agreement object and produces a set of affected commission model objects. The DMS engine then routs requests to a service process so that it will process each commission model. The service effectively maintains a pool of commission engines to process the incoming requests. The initial transaction phase does not specifically load any commission models.

Preprocessing Method

preprocess( ): This method performs any preprocessing that should occur before the commission engine is invoked. It must be called before process( ) is invoked. The method may perform three actions:

1) It uses the transaction rules to generate additional CMTransactions for the unprocessed Transactions.

2) It checks for unprocessed CancelRequests. An CancelRequest points to an Transaction that should be cancelled. For each CancelRequest, CMCancelRequests are generated for the CMTransactions that correspond the given Transaction. The Commission engine then uses the CMCancelRequests to cancel transactions.

2) During each of these two phases, the system builds a list of Agreements and CMModels that have incoming transactions. This list is used by process to determine which Commission models the DMS engine needs to run.

Processing Phase

During the processing phase, the system handles pooling agreements. The pooling engine has three stages: setup, determination and creation.

1) Setup—Takes PoolingAgreement objects and loads into memory all data structures needed to perform the next stages of pooling.

2) Determination—Takes all CMQuotaDetails that have been generated, uses the data structures that have been set up, and determines what additional quota. details should be generated. For each quota detail that should be generated, an PoolingDetail object is created.

3) Creation—Creates any new CMQuotaDetails for the current model that is being run. The pooling engine queries for all PoolingDetails that correspond to the current model, and for each such PoolingDetail, creates a new CMQuotaDetail.

As the engine runs, it calls setup on the pooling engine with all of the pooling agreements that have quotas from model m as a source. It then performs accumulation on a model m. The other two stages, determination and creation, are called from a PostAccum handler. This handler first determines which new quota details in other models need to be generated, and then performs creation, returning the new quota details to the commission engine.

Process Method

The DMS process method invokes the commission engine for each model that has new transactions or new cancel requests. The method may perform slightly different functions depending on the way the commission engine is invoked—in a local mode or in a remote mode (remote method invocation or RMI). The RMI mode allows parallel processing of the models on different machines. Both versions of the engine (local and RMI) create instances of dms.engine.ICMEngineRequest objects for each commission engine process that needs to run. The system passes these objects to instances of dms.engine.ICMEngineProcess, which invoke the commission engine. The user can customize engine processing by implementing this interface, specifying the engine that should be used in a backbone properties file. For an example of how to specify engine mode, see the source code for the default CMEngineProcess class (.dms.engine.core.CMEngineProcess). The backbone properties that can be customized are listed below.

Properties

DMSENGINE_CLASSNAME: Specifies which engine to run. The defaults is.dms.engine.local.LocalDMSEngine.

CMENGINE_PROCESS_CLASSNAME: Specifies which class to use to invoke the CM Engine. Defaults to .dms.engine.core.CMEngineProcess.

Embodiment of General Purpose Computer Environment

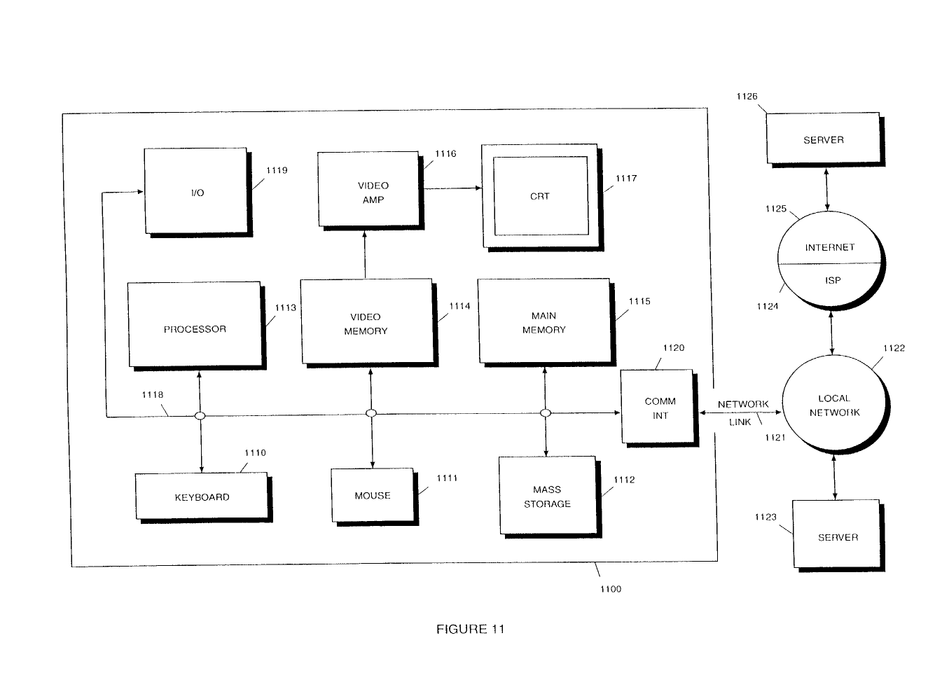

An embodiment of the invention can be implemented as computer software in the form of computer readable program code executed on one or more general-purpose computers such as the computer 1100 illustrated in FIG. 11. A keyboard 1110 and mouse 1111 are coupled to a bi-directional system bus 1118 (e.g., PCI, ISA or other similar architecture). The keyboard and mouse are for introducing user input to the computer system and communicating that user input to central processing unit (CPU) 1113. Other suitable input devices may be used in addition to, or in place of, the mouse 1111 and keyboard 1110. I/0 (input/output) unit 1119 coupled to bi-directional system bus 1118 represents possible output devices such as a printer or an A/V (audio/video) device.

Computer 1100 includes video memory 1114, main memory 1115, mass storage 1112, and communication interface 1120. All these devices are coupled to a bi-directional system bus 1118 along with keyboard 1110, mouse 1111 and CPU 1113. The mass storage 1112 may include both fixed and removable media, such as magnetic, optical or magnetic optical storage systems or any other available mass storage technology. The system bus 1118 provides a means for addressing video memory 1114 or main memory 1115. The system bus 1118 also provides a mechanism for the CPU to transferring data between and among the components, such as main memory 1115, video memory 1114 and mass storage 1112.

In one embodiment of the invention, the CPU 1113 is a microprocessor manufactured by Motorola, such as the 680X0 processor, an Intel Pentium III processor, or an UltraSparc processor from Sun Microsystems. However, any other suitable processor or computer maybe utilized. Video memory 1114 is a dual ported video random access memory. One port of the video memory 1114 is coupled to video accelerator 1116. The video accelerator device 1116 is used to drive a CRT (cathode ray tube), and LCD (Liquid Crystal Display), or TFT (Thin-Film Transistor) monitor 1117. The video accelerator 1116 is well known in the art and may be implemented by any suitable apparatus. This circuitry converts pixel data stored in video memory 1114 to a signal suitable for use by monitor 1117. The monitor 1117 is a type of monitor suitable for displaying graphic images.

The computer 1100 may also include a communication interface 1120 coupled to the system bus 1118. The communication interface 1120 provides a two-way data communication coupling via a network link 1121 to a network 1122. For example, if the communication interface 1120 is a modem, the communication interface 1120 provides a data communication connection to a corresponding type of telephone line, which comprises part of a network link 1121. If the communication interface 1120 is a Network Interface Card (NIC), communication interface 1120 provides a data communication connection via a network link 1121 to a compatible network. Physical network links can include Ethernet, wireless, fiber optic, and cable television type links. In any such implementation, communication interface 1120 sends and receives electrical, electromagnetic or optical signals which carry digital data streams representing various types of information.

The network link 1121 typically provides data communication through one or more networks to other data devices. For example, network link 1121 may provide a connection through local network 1122 to a host computer 1123 or to data equipment operated by an Internet Service Provider (ISP) 1124. ISP 1124 in turn provides data communication services through the worldwide packet data communication network now commonly referred to as the “Internet” 1125. Local network 1122 and Internet 1125 both use electrical, electromagnetic or optical signals that carry digital data streams to files. The signals through the various networks and the signals on network link 1121 and through communication interface 1120, which carry the digital data to and from computer 1100, are exemplary forms of carrier waves for transporting the digital information.

The computer 1100 can send messages and receive data, including program code, through the network(s), network link 1121, and communication interface 1120. In the Internet example, server 1126 might transmit a requested code for an application program through Internet 1125, ISP 1124, local network 1122 and communication interface 1120.

In one embodiment of the invention a thin-client device is configured to interface with the computer system described above via a computer network. In other instances (e.g., when a smart mobile device is utilized) some or all of the components discussed above are incorporated into the device. It will be evident to one of ordinary skill in the art that the computer systems described above are for purposes of example only. An embodiment of the invention may be implemented in any type of computer system or programming or processing environment.

Thus, a method and apparatus for generating a document has been described. Particular embodiments described herein are illustrative only and should not limit the present invention thereby. The claims and their full scope of equivalents define the invention.

What is claimed is:

1. In a computer system, a method for generating documents comprising:
obtaining at least one of a plurality of components from a document template;
obtaining at least one relationship from said document template, said relationship defining an association between said plurality of components and a document to be generated;
generating said document according to said at least one relationship;
providing said document to a user.

2. The method of claim 1 wherein a configuration engine performs said generating said document.

3. The method of claim 1 wherein at least one of said plurality of components comprises a compensation component.

4. The method of claim 3 wherein said compensation component defines a commission associated with the sale of a product.

5. The method of claim 4 wherein said commission comprises monetary compensation to be distributed to a sales representative.

6. The method of claim 3 wherein said compensation component is modeled using a commission model.

7. The method of claim 1 wherein at least one of said plurality of components comprises a textual component.

8. The method of claim 7 wherein said textual component comprises pre-defined textual elements.

9. The method of claim 8 wherein said pre-defined textual elements are generated by a third-party.

10. The method of claim 6 wherein said at least one textual component is associated with a product.

11. The method of claim 1 wherein said document comprises a contract.

12. The method of claim 1 wherein at least one of said plurality of components are defined as a standard component, required component, or optional component.

11. The method of claim 1 wherein said interrelationship comprises an includes relation.

12. The method of claim 1 wherein said interrelationship comprises an excludes relation.

13. The method of claim 1 wherein said interrelationship comprises a requires relation.

14. The method of claim 1 wherein said interrelationship comprises an optional relation.

15. In a computer system, a method for generating documents comprising:
obtaining at least one compensation component from a document template wherein said at least one compensation component is associated with at least one product;
obtaining at least one textual component from a document template, wherein said at least one textual component comprises textual elements;
obtaining at least one relationship that defines an interrelationship between said at least one compensation component or said at least one textual component and a document to be generated;
generating said document associated with said product according to said at least one relationship.

16. The method of claim 15 wherein a configuration engine performs said generating said document associated with said product.

17. The method of claim 15 wherein said compensation component comprises a commission associated with the sale of said product.

18. The method of claim 17 wherein said commission comprises monetary compensation to be distributed to a sales representative.

19. The method of claim 17 wherein said compensation component is modeled using a commission model.

20. The method of claim 15 wherein said textual elements are pre-defined.

21. The method of claim 20 wherein said textual elements of said document are associated with said product.

22. The method of claim 15 wherein said document comprises a contract.

23. The method of claim 20 wherein said textual components are defined by a first user.

24. The method of claim 15 wherein at least one of said plurality of components is defined as a standard component, required component, or optional component.

25. The method of claim 15 wherein said at least one relationship comprises an includes relation.

26. The method of claim 15 wherein said at least one relationship comprises an excludes relation.

27. The method of claim 15 wherein said at least one relationship comprises a requires relation.

28. The method of claim 15 wherein said interrelationship comprises an optional relation.

29. In a computer system, a method for enabling a user to define configurable documents comprising:
presenting a modeling interface to a user;
obtaining modeling information from said user via said modeling interface;
generating at least one compensation plan from said modeling information;
generating at least one compensation component by creating a relation between said at least one compensation plan and at least one product, said association representative of said at least one product said user wishes to distribute;
obtaining at least one textual element;
generating at least one textual component comprising said at least one textual element by creating a relation between said at least one textual component and said at least one product;
associating said at least one compensation component and said at least one textual component with a document template.

30. The method of claim 29 further comprising:
providing said document template to a configuration engine;
processing of said document template at said configuration engine to generate a document.

31. The method of claim 30 wherein said processing comprises:
obtaining one or more relations associated with said at least one compensation component and said at least one textual component from said document template;
applying said one or more relations to generate a document;
providing said document.

32. The method of claim 31 wherein said one or more relations comprises an includes relation.

33. The method of claim 31 wherein said one or more relations comprises an excludes relation.

34. The method of claim 31 wherein said one or more relations comprises a requires relation.

35. A computer program product comprising:
a computer usable medium having computer readable program code for generating documents embodied therein, said computer readable program code configured to:
obtain at least one of a plurality of components from a document template;
obtain at least one relationship from said document template, said relationship defining an association between said plurality of components and a document to be generated;
generate said document according to said at least one relationship;
provide said document to a user.

36. The computer program product of claim 35 wherein a configuration engine performs said generating said document.

37. The computer program product of claim 35 wherein at least one of said plurality of components comprises a compensation component.

38. The computer program product of claim 37 wherein said compensation component defines a commission associated with the sale of a product.

39. The computer program product of claim 38 wherein said commission comprises monetary compensation to be distributed to a sales representative.

40. The computer program product of claim 38 wherein said compensation component is modeled using a commission model.

41. The computer program product of claim 35 wherein at least one of said plurality of components comprises a textual component.

42. The computer program product of claim 41 wherein said textual component comprises pre-defined textual elements.

43. The computer program product of claim 42 wherein said pre-defined textual elements are generated by a third-party.

44. The computer program product of claim 41 wherein said textual component is associated with a product.

45. The computer program product of claim 35 wherein said document comprises a contract.

46. The computer program product of claim 35 wherein said document comprises any document associated with a business transaction.

47. The computer program product of claim 35 wherein at least one of said plurality of components is defined as a standard component, required component, or optional component.

48. The computer program product of claim 35 wherein said interrelationship comprises an includes relation.

49. The computer program product of claim 35 wherein said interrelationship comprises an excludes relation.

50. The computer program product of claim 35 wherein said interrelationship comprises a requires relation.

51. The computer program product of claim 35 wherein said interrelationship comprises an optional relation.

52. A computer program product comprising:
a computer usable medium having computer readable program code embodied therein, said computer readable program code configured to:
obtain at least one compensation component from a document template wherein said at least one compensation component is associated with at least one product;
obtain at least one textual component from a document template, wherein said at least one textual component comprises textual elements;
obtain at least one relationship that defines an interrelationship between said at least one compensation component or said at least one textual component and a document to be generated;
generate said document associated with said product according to said at least one relationship.

53. The computer program product of claim 52 wherein a configuration engine performs said generating said document associated with said product.

54. The computer program product of claim 52 wherein said compensation component comprises a commission associated with the sale of said product.

55. The computer program product of claim 54 wherein said commission comprises monetary compensation to be distributed to a sales representative.

56. The computer program product of claim 54 wherein said compensation component is modeled using a commission model.

57. The computer program product of claim 52 wherein said textual elements are pre-defined.

58. The computer program product of claim 52 wherein said textual elements of said document are associated with said product.

59. The computer program product of claim 52 wherein said document comprises a contract.

60. The computer program product of claim 52 wherein said textual components are defined by a first user.

61. The computer program product of claim 52 wherein said at least one compensation component or said textual component may be defined as a standard component, required component, or optional component.

62. The computer program product of claim 52 wherein said at least one relationship comprises an includes relation.

63. The computer program product of claim 52 wherein said at least one relationship comprises an excludes relation.

64. The computer program product of claim 52 wherein said at least one relationship comprises a requires relation.

65. The computer program product of claim 52 wherein said interrelationship comprises an optional relation.

66. A computer program product comprising:
a computer usable medium, said computer usable medium comprising computer readable program code configured to:
present a modeling interface to a user;
obtain modeling information from said user via said modeling interface;
generate at least one compensation plan from said modeling information;
generate at least one compensation component by creating a relation between said at least one compensation plan and at least one product, said association representative of said at least one product said user wishes to distribute;
obtain at least one textual element;
generate at least one textual component comprising said at least one textual element by creating a relation between said at least one textual component and said at least one product;
associate said at least one compensation component and said at least one textual component with a document template.

67. The computer program product of claim 66 further comprising:
providing said document template to a configuration engine;
processing of said document template at said configuration engine to generate a document.

68. The computer program product of claim 30 wherein said processing comprises:
obtaining one or more relations associated with said at least one compensation component and said at least one textual component from said document template;
applying said one or more relations to generate a document;
providing said document.

69. The computer program product of claim 68 wherein said one or more relations comprises an includes relation.

70. The computer program product of claim 68 wherein said one or more relations comprises an excludes relation.

71. The computer program product of claim 68 wherein said one or more relations comprises a requires relation.

72. The computer program product of claim 68 wherein said one or more relations comprises an optional relation.
